(19) United States
(12) Patent Application Publication
(10) Pub. No.: US 2011/0178718 A1
(43) Pub. Date: Jul. 21, 2011

(54) CHARACTERIZATION OF BIOLOGICAL SAMPLES

(75) Inventors: Ronald R. Henriquez, College Station, TX (US); Jeffery D. Johnson, College Station, TX (US); Simon Sheather, College Station, TX (US); Ronald D. MacFarlane, College Station, TX (US); Catherine J. McNeal, Temple, TX (US); Craig D. Larner, College Station, TX (US)

(73) Assignees: Scott and White Memorial Hospital and Scott, Sherwood, and Brindley Foundation, Temple, TX (US); THE TEXAS A&M UNIVERSITY SYSTEM, College Station, TX (US)

(21) Appl. No.: 12/966,366

(22) Filed: Dec. 13, 2010

Related U.S. Application Data
(63) Continuation-in-part of application No. PCT/US2009/047211, filed on Jun. 12, 2009.
(60) Provisional application No. 61/061,509, filed on Jun. 13, 2008.
(60) Provisional application No. 61/285,645, filed on Dec. 11, 2009.

(51) Int. Cl. G06F 19/00

(52) U.S. Cl. 702/19

(57) ABSTRACT

A method of characterizing a biological sample comprising separating the biological sample into constituents; observing the separated constituents; applying statistical classification modeling to the observed constituents; deriving quantifiable data from the applied statistical classification modeling; and analyzing the data from the applied statistical classification modeling to assess a donor of the biological compounds' health. A system for characterizing a biological sample comprising a biological sample separator, wherein the biological sample separator functions to separate the biological sample into constituents; a constituent observer, wherein the constituent observer functions to confirm and qualify the presence of the constituent; a constituent statistical processor, wherein the constituent statistical processor functions to apply statistical classification modeling to the observed constituent to derive representative data; and a statistical analyzer, wherein the statistical analyzer functions to compare the representative data to benchmark values to derive a predictor for a health concern. Also disclosed is a method comprising identifying a disease of interest; identifying one or more organisms having the disease of interest; obtaining one or more biological samples from the organisms having the disease of interest; identifying one or more characteristics of the biological samples; providing quantifiable data that represents the characteristics of the biological sample; and employing a statistical classification method that utilizes the quantifiable data to identify one or more discriminant directions wherein the discriminant directions relate the characteristics of the biological sample to the disease of interest.

### CROSS-REFERENCE TO RELATED APPLICATIONS

The present application is a continuation-in-part of PCT/US2009/047211, filed Jun. 12, 2009, which claims priority to U.S. Provisional Patent Application Ser. No. 61/061,509 filed Jun. 13, 2008 by Henriquez et al. and entitled “Characterization of Biological Samples,” which are both incorporated herein by reference as if reproduced in their entirety. The present application also claim priority to U.S. Provisional Application Ser. No. 61/285,645, filed Dec. 11, 2009, which is also incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Cardiovascular disease or cardiovascular diseases refers to the class of diseases that involve the heart or blood vessels (e.g., arteries, capillaries, and veins). Cardiovascular disease refers to any disease affecting the cardiovascular system, although it is commonly used to refer to those related to atherosclerosis (e.g., arterial disease).

The American Heart Association estimates that, for the year 2006, 80,000,000 people in the United States had one or more forms of CVD, including 73,600,000 with high blood pressure, 16,800,000 with coronary heart disease, 7,900,000 having suffered a myocardial infarction, 9,800,000 cases of angina, 6,500,000 strokes, and 5,700,000 cases of heart failure. Cardiovascular diseases claimed 864,480 lives in 2005 (final mortality) (35.3 percent of all deaths or 1 of every 2.8 deaths).

Conventionally, biomarkers have been thought to offer a more detailed risk of cardiovascular disease. For example, biomarkers which may tend to reflect a higher risk for cardiovascular disease include elevated fibrinogen and PAI-1 blood concentrations, elevated homocysteine levels; elevated blood levels of asymmetric dimethylarginine; high inflammation as measured by C-reactive protein; and elevated blood levels of brain natriuretic peptide (also known as B-type) (BNP). However, use of these biomarkers can be inconclusive and difficult to apply in a clinical setting. Further, some individuals develop CVD despite lacking any one or more of the conventional biomarkers.

Determination that an individual is at risk for the development of a disease such as CVD or is in some stage of development of a disease such as CVD would allow for either treatment of the disease state or the implementation of measures to prevent the onset of a disease state or dysfunction (e.g., CVD). Thus, there exists a need for rapid, accurate, and clinically implementable means of assessing an individual's risk for the development of a disease state or dysfunction such as CVD.

### SUMMARY

Disclosed herein is a method of characterizing a biological sample comprising: separating the biological sample into constituents; observing the separated constituents; applying statistical classification modeling to the observed constituents; deriving quantifiable data from the applied statistical classification modeling; and analyzing the data from the applied statistical classification modeling to assess a donor of the biological compounds' health. The biological sample may comprise blood, serum, proteins, lipoproteins, cells, cell constituents, microorganisms, DNA, or combinations thereof. Separation of the biological sample into constituents may be effected by density gradient ultracentrifugation, gradient gel electrophoresis, capillary electrophoresis, ultracentrifugation-vertical auto profile, nuclear magnetic resonance, tube gel electrophoresis, chromatography, or combinations thereof. The constituents may be separated according to size (rate zonal), density (isopycnic), or combinations thereof. The centrifugation may be via centrifuges comprising fixed angle rotors, vertical tube rotors, swinging bucket rotors, or combinations thereof. The biological sample may be suspended in media comprising inorganic salts (cesium chloride, potassium bromide, sodium chloride), sucrose, a synthetic polysaccharide made by crosslinking sucrose, a suspension of silica particles coated with polyviynlpyrrolidone, derivatives of metrizoic acid, dimers of metrizoic acid, Optiprep®, and metal ion chelate complexes. The metal ion chelate complexes may comprise metal ions and chelating agents. The metal ions may comprise copper, iron, bismuth, zinc cadmium, calcium, thorium, manganese, lithium, sodium, potassium, cesium, magnesium, calcium, ammonium, ammonium complexes, tetrabutylammonium, or combinations thereof. The chelating agents may comprise polydentate ligands. The polydentate ligands may comprise oxalate, ethylenediamine, diethylenetriamine, 1,3,5 triminocyclohexane, ethlylenediaminetertaacetic acid (EDTA), or combinations thereof. The metal ion chelate complexes may comprise CsBiEDTA, NaCuEDTA, NaFeEDTA, NaBiEDTA, Cs₂CdEDTA, Na₂CdEDTA, or combinations thereof. The observed constituents may comprise low density lipoprotein (LDL), very low density lipoprotein (VLLP), intermediate density lipoprotein (IDL), high density lipoprotein (HDL), lipoprotein(a) (Lp(a)), bTRL, dTRL, LDL-1, LDL-2, LDL-3, LDL-4, LDL-5, HDL-2b, HDL-2a, HDL-3b, HDL-3c, APOC1HDL, TC, LDL-C, HDL-C, TG, or combinations thereof. Observation of the constituents may comprise photography, videography, microscopy, nuclear magnetic resonance imaging, computer scanning, human visualization, or combinations thereof. The observation of the constituents may further comprise the utilization of dyes, stains, fluorescent markers, Rayleigh scattering, computer enhancement, or combinations thereof. The observation of the constituents may comprise confirming and qualifying the presence of constituent components. The statistical classification modeling may comprise linear discrimination analysis (LDA), recursive partitioning (RP), sliced average variance estimation (SAVE), sliced mean variance covariance (SMVCIR), or combinations thereof. The statistical classification modeling may further comprise consideration of age, hypertension, hyperlipidemia, family history, gender, tobacco use, alcohol use, other health related factors, or combinations thereof. The quantifiable data may comprise

$$\frac{TC}{{HDL}^{0.35} {LDL}^{0.25} {TG}^{0.04}} , \frac{{HDL}^{0.29} {LDL}^{0.09} {TG}^{0.11}}{TC} , \\ \frac{{HDL}^{0.59} {LDL}^{0.49} {TG}^{0.03}}{TC} , \frac{HDL \text{-} 3 b \times LDL \text{-} {5}^{0.77} {HDL}^{0.55}}{HDL - 2 {b}^{0.93} HDL - 3 {c}^{0.77}} , \\ \frac{HDL \text{-} 2 b \times LDL \text{-} {4}^{0.43}}{HDL \text{-} 2 {a}^{0.87} LDL \text{-} {5}^{0.65}} , \\ \frac{HDL \text{-} 3 b \times HDL \text{-} 3 {c}^{0.75} HDL \text{-} 2 {a}^{0.61} LDL \text{-} {2}^{0.41}}{LDL \text{-} {3}^{0.51} LSL \text{-} {5}^{0.42}} , \\ \frac{HDL \text{-} 3 b \times LDL \text{-} {2}^{0.60}}{HDL \text{-} 3 {c}^{0.83} LDL \text{-} {3}^{0.56}} , \qquad$$

or combinations thereof.
Analyzing the data from the applied statistical classification modeling may comprise comparing the data to a benchmark value. Assessment of the donor's health may be greater than 80% effective in identifying issues concerning the donor's health. Assessment of the donor's health may be greater than 85% effective in identifying issues concerning the donor's health. Assessment of the donor's health may be greater than 90% effective in identifying issues concerning the donor's health. Assessment of the donor's health may be greater than 95% effective in identifying issues concerning the donor's health. Assessment of the donor's health may be greater than 99% effective in identifying issues concerning the donor's health. Assessment of the donor's health may comprise identifying cardiovascular disease, genetic disorders, coronary heart disease, a disease that influences lipoproteins, or combinations thereof.

Also disclosed herein is a system for characterizing a biological sample comprising: a biological sample separator, wherein the biological sample separator functions to separate the biological sample into constituents; a constituent observer, wherein the constituent observer functions to confirm and qualify the presence of the constituent; a constituent statistical processor, wherein the constituent statistical processor functions to apply statistical classification modeling to the observed constituent to derive representative data; and a statistical analyzer, wherein the statistical analyzer functions to compare the representative data to benchmark values to derive a predictor for a health concern. The biological sample separator may comprise a centrifuge, a gel electrophoresis system, a chromatography system, a capillary electrophoresis system, or combinations thereof. The constituent observer may comprise a photography device, a videography device, a microscopy device, a nuclear magnetic resonance imaging device, a computer scanning device, a human visualization device, or combinations thereof. The constituent statistical processor may comprise a computer, software, a mathematical computation device, or combinations thereof. The statistical analyzer may comprise a computer, software, a mathematical computation device, or combinations thereof.

Also disclosed herein is a method of determining a benchmark for health assessment comprising: separating a biological sample into constituents; observing the separated constituents; applying statistical classification modeling to the observed constituents; correlating the observed constituents to a health concern; and performing an amount of correlations of components to health concerns to achieve a statistically significant predictor.

Also disclosed herein is a method of assessing a individual's health comprising: applying statistical classification modeling to an individual's assessment sample; deriving quantifiable data from the applied statistical classification modeling; and analyzing the data from the applied statistical classification modeling to assess the individual's health. The statistical classification modeling may comprise linear discrimination analysis (LDA), recursive partitioning (RP), sliced average variance estimation (SAVE), sliced mean variance covariance (SMVCIR), or combinations thereof. The quantifiable data may comprise

$$\frac{TC}{{HDL}^{0.35} {LDL}^{0.25} {TG}^{0.04}} , \frac{{HDL}^{0.29} {LDL}^{0.09} {TG}^{0.11}}{TC} , \frac{{HDL}^{0.59} {LDL}^{0.49} {TG}^{0.03}}{TC} , \frac{HDL \text{-} 3 b \times LDL \text{-} {5}^{0.77} {HDL}^{0.55}}{HDL \text{-} 2 {b}^{0.93} HDL \text{-} 3 {c}^{0.77}} , \frac{HDL \text{-} 2 b \times LDL \text{-} {4}^{0.43}}{HDL \text{-} 2 {a}^{0.87} LDL \text{-} {5}^{0.65}} , \frac{HDL \text{-} 3 b \times HDL \text{-} 3 {c}^{0.75} HDL \text{-} 2 {a}^{0.61} LDL \text{-} {2}^{0.41}}{LDL \text{-} {3}^{0.51} LDL \text{-} {5}^{0.42}} , \frac{HDL \text{-} 3 b \times LDL \text{-} {2}^{0.60}}{HDL \text{-} 3 {c}^{0.83} LDL \text{-} {3}^{0.56}} ,$$

or combinations thereof. Analyzing the data from the applied statistical classification modeling may comprise comparing the data to a benchmark value. Assessment of the individual's health may be greater than 80% effective in identifying issues concerning the individual's health. Assessment of the individual's health may be greater than 85, effective in identifying issues concerning the individual's health. Assessment of the individual's health may be greater than 90% effective in identifying issues concerning the individual's health. Assessment of the individual's health may be greater than 95% effective in identifying issues concerning the individual's health. Assessment of the individual's health may be greater than 99% effective in identifying issues concerning the individual's health. Assessment of the individual's health may comprise identifying cardio vascular disease, genetic disorders, coronary heart disease, a disease that influences lipoproteins, or combinations thereof.

Also disclosed herein is a method of determining a benchmark for health assessment comprising: applying statistical classification modeling to observed assessment factors; correlating the observed assessment factors to a health concern; and performing an amount of correlations of components to health concerns to achieve a statistically significant predictor.

Also disclosed herein is a system that analyzes a biological sample comprising: a separator; a device for measuring/profiling the distribution of constituents in a separated sample; and a program that statistically analyzes the distribution/profile and classifies the sample according to the output of the analysis. The classification may comprise a diagnosis. The classification may comprise a diagnosis related to CVD. The device may permit observation of a profile of a distribution of constituents in a separated sample.

Also disclosed herein is a method comprising diagnosing CVD with at least 50, 60, 70, 80, 85, 90, 95, 99, or 99.9 percent certainty. Diagnosing may comprise operating on a blood sample having normal or better than normal HDL-c levels, normal or better than normal LDL-c levels, or combinations thereof. Operating may comprise: calculating certain ratios of lipoproteins; executing LDA; executing SAVE; or combinations thereof.

Also disclosed herein is a method of diagnosing CVD comprising analyzing a biological sample via: ratios of lipoproteins, LDA, SAVE, or combinations thereof. Analyzing a biological sample may comprise operating on a lipoprotein distribution profile with LDA, SAVE, or combinations thereof.

Also disclosed herein is a method or system according to any foregoing embodiment, wherein the embodiments are combined in any desirable or operable arrangement to provide multiple embodiments.

Also disclosed herein is a system for characterizing a biological sample comprising: means for separating the biological sample into constituents; means for observing the separated constituents; means for applying statistical classification modeling to the observed constituents; means for deriving quantifiable data from the applied statistical classification modeling; and means for analyzing the data from the applied statistical classification modeling to assess a donor of the biological compounds' health.

Also disclosed herein is a system for determining a benchmark for health assessment comprising: means for separating a biological sample into constituents; means for observing the separated constituents; means for applying statistical classification modeling to the observed constituents; means for correlating the observed constituents to a health concern; and means for performing a number of correlations of components to health concerns to achieve a statistically significant predictor.

Also disclosed herein is a system for assessing an individual's health comprising: means for applying statistical classification modeling to an individual's assessment sample; means for deriving quantifiable data from the applied statistical classification modeling; and means for analyzing the data from the applied statistical classification modeling to assess the individual's health.

Also disclosed herein is a system for determining a benchmark for health assessment comprising: means for applying statistical classification modeling to observed assessment factors; means for correlating the observed assessment factors to a health concern; and means for performing an amount of correlations of components to health concerns to achieve a statistically significant predictor.

Also disclosed herein is a patient therapy strategy comprising all or a portion of any foregoing method or system.

Also disclosed herein is a method of diagnosing and/or treating a patient comprising all or a portion of any foregoing method or system.

Also disclosed herein is a computerized implementation, instantiation, or embodiment of all or a portion of any foregoing system or method.

Also disclosed herein is a method comprising: selecting a general population; selecting a disease or interest; selecting a population subset whose membership is based on a known shared characteristic; obtaining a biological sample from members of the population subset; deriving at least one attribute of the biological samples; using a statistical correlation method to calculate a correlative between the at least one attribute and the disease of interest; selecting a subject wherein it is unknown if the subject has the known shared characteristic; obtaining a biological sample from the subject; deriving at least one attribute of the biological sample from the subject wherein the sample and attribute are the same as the samples and attributes derived for the population subset; using a statistical correlation method to calculate a correlative between the attribute of the biological sample from the subject and the disease of interest; and determining the membership of the subject in the population subset wherein the subject is a member of the population subset if the correlative derived based on the attributes of the subject's biological sample approximates the correlative derived based on the attributes of the population subset's biological samples.

### BRIEF DESCRIPTION OF THE DRAWINGS

FIG. 1 is a schematic of a method of developing a correlative between an attribute of a biological sample and a disease.

FIG. 2 is a method of assessing a risk for the development of CVD.

FIG. 3 is a plot of the ratio of two correlatives for the samples from Example 1.

FIG. 4 is a plot of two linear combinations derived from analysis of the samples from Example 2.

FIG. 5 is a plot of the ratio of two correlatives obtained for the samples from Example 3.

FIG. 6 is a plot of the two linear combinations derived from analysis of the samples from Example 3.

FIG. 7A is an illustration of an image of the liprotein-metal ion chelate complex (far left panel), a liproprotein profile (middle panel) and the integrated intensities (far right panel).

FIG. 7B is a plot of the ratio of two correlatives for the samples from Example 8.

FIG. 8 is a plot of the two dimensional SAVE analysis for the samples from Example 8.

FIG. 9 is a plot of LDA and SAVE for the samples from Example 8.

### DETAILED DESCRIPTION

It should be understood at the outset that although illustrative implementations of one or more embodiments are illustrated below, the disclosed systems and methods may be implemented using any number of techniques, whether currently known or in existence. The disclosure should in no way be limited to the illustrative implementations, drawings, and techniques illustrated below, but may be modified within the scope of the appended claims along with their full scope of equivalents.

In an embodiment, one or more methods disclosed herein may be suitable for developing a correlative. Such a correlative may be useful for identifying individuals who present with or are at an elevated risk for a development of a disease state, dysfunction, or disorder (hereinafter collectively termed a disease) such as CVD. In an embodiment, the correlative functions to relate an attribute of a biological sample obtained from an individual to a disease. For example the correlative may relate one or more of attributes of a biological sample (e.g., lipoprotein profile) to the existence or potential occurrence of CVD. In an embodiment, a correlative of the type described herein may be utilized to assess the presence or absence of a disease and/or an individual's risk for the onset or occurrence of a disease. In an embodiment, one or more methods disclosed herein may be suitable for predicting the occurrence and/or risk of occurrence of CVD in an individual.

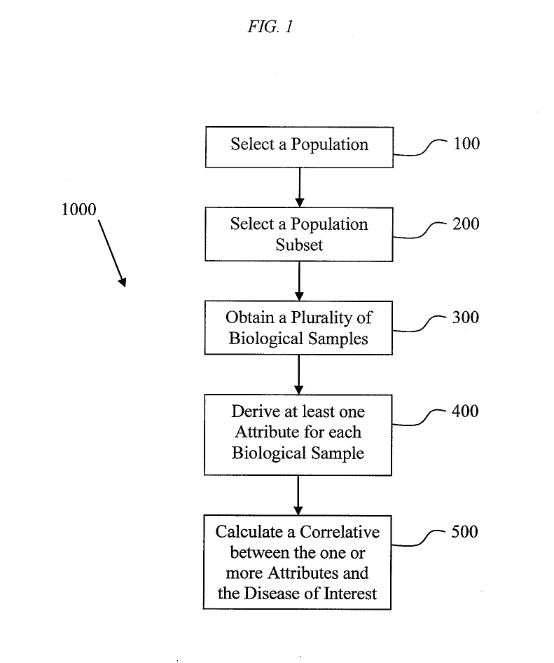

Referring to FIG. 1, a method of developing a correlative between an attribute of a biological sample obtained from an individual and a disease, referred to herein as a “disease correlative development method” (DCD) 1000, is illustrated schematically. In an embodiment, the DCD 1000 generally comprises selecting a general population, selecting a population subset where the members of the population subset comprise at least one shared characteristic, obtaining a biological sample from members of the population subset, deriving at least one attribute for each biological sample, and calculating a correlative between the attributes of the biological sample and the shared characteristic. Herein the general population refers to that collection of organisms for which a correlative between an attribute of a biological sample obtained from members of the general population and a disease is to be made.

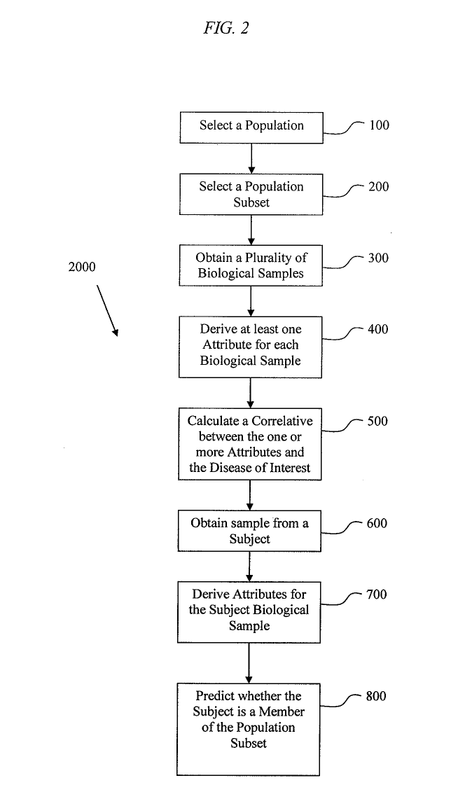

Referring to FIG. 2, in an embodiment, a method of assessing a risk for the development of CVD, referred to herein as a “disease risk assessment method” (DRA) 2000 is illustrated. In an embodiment, the DRA 2000 generally comprises selecting a population of organisms, identifying a population subset, obtaining biological samples from members of the population subset, and developing a correlative between at least one attribute of the biological sample and a disease wherein the correlative is indicative of and/or predictive for a disease. The method may further comprise obtaining a biological sample from a member of the general population, determining the attributes of the biological sample and predicting whether the subject is a member of the population subset.

In an embodiment, the DCD 1000 and the DRA 2000 comprise selecting a general population 100. The general population will comprise any suitable collection of organisms sharing a biological relationship and whose disease and/or risk for disease is to be assessed. Nonlimiting examples of such a population include mammals, humans, dogs, cats, horses, cattle, and chickens. In a particular embodiment, the general population will comprise humans.

In an embodiment, the DCD 1000 and the DRA 2000 comprise selecting a population subset 200. As used herein, “population subset” refers a subset the general population, wherein all members of the population subset comprise at least one shared characteristic.

In an embodiment, the shared characteristic comprises the disease which is to be correlated to the one or more attributes of the biological sample, referred to herein as the disease of interest (DOI). For example, the population subset may comprise members of the general population symptomatic for the DOI. Alternatively, the population subset may comprise members of the general population asymptomatic for the DOI. Alternatively, the population subset comprises members of the general population having risk factors (e.g., genetic, lifestyle) for the DOI. Alternatively, the population subset may comprise members of the general population for which the presence of the DOI is established by alternative methodologies. Alternatively, the population subset may comprise members of the general population for which the absence of the DOI is established by alternative methodologies.

In a particular embodiment, the population subset comprises humans known to have CVD. In an alternative embodiment, the population subset comprises humans known to not have CVD.

In an embodiment, the DCD 1000 and the DRA 2000 further comprise obtaining a biological sample from members of the population subset 300. Nonlimiting examples of biological samples include proteins, lipoproteins, cells, cell constituents, microorganisms, DNA, or combinations thereof.

In an embodiment, the biological sample is obtained by any method known to one of ordinary skill in the art and compatible with the methodologies described herein. For example, a blood sample may be obtained from a member of the population subset.

In a specific embodiment, the biological sample is a blood sample. A blood sample may be obtained from a subject according to methods well known in the art. In some embodiments, a drop of blood is collected from a pin prick made in the skin of a subject. Blood may be drawn from a subject from any part of the body (e.g., a finger, a hand, a wrist, an arm, a leg, a foot, an ankle, a stomach, and a neck) using techniques known to one of skill in the art, in particular methods of phlebotomy known in the art. In a specific embodiment, venous blood is obtained from a subject and utilized in accordance with the methods of this disclosure. In another embodiment, arterial blood is obtained and utilized in accordance with the methods of this disclosure. The composition of venous blood varies according to the metabolic needs of the area of the body it is servicing. In contrast, the composition of arterial blood is consistent throughout the body.

Venous blood can be obtained from the basilic vein, cephalic vein, or median vein. Arterial blood can be obtained from the radial artery, brachial artery or femoral artery. A vacuum tube, a syringe or a butterfly may be used to draw the blood. Typically, the puncture site is cleaned, a tourniquet is applied approximately 3-4 inches above the puncture site, a needle is inserted at about a 15-45 degree angle, and if using a vacuum tube, the tube is pushed into the needle holder as soon as the needle penetrates the wall of the vein. When finished collecting the blood, the needle is removed and pressure is maintained on the puncture site. Heparin or another type of anticoagulant may be in the tube or vial that the blood is collected in so that the blood does not clot.

In some embodiments, the collected blood is stored prior to being subjected to further processing as will be described herein. In one embodiment, the collected blood is stored at room temperature (i.e., approximately 22° C.). In another embodiment, the collected blood is stored at refrigerated temperatures, such as 4° C., prior to use. In some embodiments, a portion of the blood sample is used in accordance with this disclosure at a first instance of time whereas one or more remaining portions of the blood sample is stored for a period of time for later use. This period of time can be an hour or more, a day or more, a week or more, a month or more, a year or more, or indefinitely. For long term storage, storage methods well known in the art, such as storage at cryo temperatures (e.g., below −60° C.) can be used.

Those of skill in the art will further appreciate that the size of the biological sample obtained will vary depending upon the type of biological sample to be obtained, the method by which it is obtained, and other variables. In an embodiment, the biological sample comprises blood and the sample size may be about 25 mL, alternatively, less than about 25 mL alternatively, less than about 5 mL, alternatively, less than about 1 mL, alternatively, less than about 0.5 mL, alternatively, less than about 0.1 mL. In an embodiment, the biological sample comprises blood and a sample size of approximately 50 μl is collected onto a substrate (e.g., filter paper) which may be treated (prior and/or subsequent to) contact with the biological sample. Treatment may include materials and/or processes that inhibit the degradation of the biological sample.

In another embodiment, the biological sample comprises serum and/or plasma. Serum and/or plasma may be derived from the blood sample by methods well known to those of skill in the art. For example, blood may be clotted, and the serum or plasma isolated by low speed centrifugation.

In an embodiment, the DCD 1000 and the DRA 2000 further comprise deriving at least one attribute of the biological sample 400. Such attributes generally comprise various quantitative or qualitative characteristics. For example, the attribute may be the nature and amount of one or more components of the biological sample.

In an embodiment, the attribute of the biological sample derived is the nature and amount of lipoproteins present in the biological sample. Herein a lipoprotein refers to a biochemical assembly that contains both protein and lipids. The lipids or their derivatives may be covalently or non-covalently bound to the proteins. Lipoproteins differ in the ratio of protein to lipids, and in the particular apoproteins and lipids that they contain. Lipoproteins are typically divided into classes based on differences in density and composition. Such classes include very low density lipoprotein (VLDL), low density lipoproteins (LDL), intermediate density lipoproteins (IDL), high density lipoproteins (HDL) and lipoprotein(a) (Lp(a)). Lipoproteins may be further divided in subclasses based on differences in density and composition. Such subclasses include buoyant triglyceride-rich lipoprotein (bTRL), dense triglyceride-rich lipoprotein (dTRL), LDL-1, LDL-2, LDL-3, LDL-4, LDL-5, HDL-2b, HDL-2a, HDL-3a, HDL-3b, and HDL3c.

In an embodiment, deriving the attribute of the biological sample comprises determining the lipoprotein profile of the biological sample. Herein the lipoprotein profile refers to information on the amount and type of lipoprotein subclasses derived from the biological sample.

The lipoprotein profile of the biological sample may be determined by first separating the biological sample into lipoprotein subclasses. Separation of the biological sample into lipoprotein subclasses may be carried using any methodology compatible with the currently disclosed process. For example, the biological sample may be separated into lipoprotein subclasses by an isopycnic and/or zonal gradient ultracentrifugation process. Processes of utilizing isopycnic gradient ultracentrifugation process to obtain lipoprotein subclasses are discussed in greater detail in U.S. Pat. No. 7,320,893, U.S. Pat. No. 6,753,185, and U.S. Pat. No. 6,593,145, each of which is incorporated herein in its entirety.

In an embodiment, the biological sample comprises a blood sample, alternatively the biological sample comprises serum. Although the following embodiments are discussed with reference to serum, one or more of the embodiments disclosed herein may be similarly applicable to other biological samples.

Separation of the serum into lipoprotein subclasses may involve staining the serum with a visualization dye and subjecting the stained serum to ultracentrifugation. The visualization dye may be chosen to interact with the surface of the lipoproteins and exhibit saturation kinetics such that uptake of the visualization dye by the lipoprotein is proportional to the lipoprotein concentration. In various embodiments, the visualization dye is a visible or fluorescent dye. Examples of such dyes include but are not limited to NBD C₆-ceramide (6-[N-(7-nitrobenz-2-oxa-1,3-diazole-4-yl)amino] hexanoyl-D-erythro-sphingosine and Sudan Black B. Further, the visualization dye may be a lipophilic or protein stain. Nonlimiting examples of a lipophilic or protein stain suitable for use in this disclosure include Sudan Black B and Coomassie Brilliant Blue R. The visualization dye can also be a fluorescent membrane probe. Nonlimiting examples of such probes suitable for use in this disclosure include NBD, DiI (3,3′-dioctadecylindocarbocyanine) (D-282), DiA (N,N-dipentadecylaminostyrilpyridinium), (D-3883), BODIPY (dipyrrometheneboron difluoride) C5-HPC (D-3795).

In embodiments, a method for separating a biological sample into lipoprotein subclasses comprises suspending the stained serum in a density gradient forming solution (DGFS). The mixture of stained serum and DGFS is termed the unseparated solution.

The DGFS may comprise inorganic salts (cesium chloride, potassium bromide, sodium chloride), sucrose, a synthetic polysaccharide made by crosslinking sucrose, a suspension of silica particles coated with polyviynlpyrrolidone, derivatives of metrizoic acid, dimers of metrizoic acid, Optiprep®, metal ion chelate complexes, or combinations thereof.

In an embodiment, the DGFS comprises one or more metal ion chelate complexes. As used herein, the term “metal ion chelate complex” refers to a complex formed between a metal ion and a chelating agent. The metal ion can generally be any metal ion. Examples of metal ions which may be employed in the present disclosure include, but are not limited to ions of copper, iron, bismuth, zinc, cadmium, calcium, thorium and manganese.

As will be appreciated by one of skill in the art, the term “chelating agent” refers to a particular type of ligand that can form a complex with a metal ion, wherein the ligand comprises more than one atom having unshared pairs of electrons that form bonds or associations with the same metal ion. Chelating agents are also referred to as polydentate ligands. Examples of chelating agents suitable for use in the present disclosure include, but are not limited to oxalate, ethylenediamine, diethlyenetriamine, 1,3,5-triaminocyclohexane and ethylenediaminetetraacetic acid (EDTA). In an embodiment, the chelating agent comprises EDTA.

Metal ion chelate complexes may further comprise one or more positively charged counter-ions to balance the overall charge of the complex. Examples of counter-ions include, but are not limited to lithium, sodium, potassium, cesium, magnesium, calcium and ammonium as well as counter-ions such as ammonium complexes, for example tetrabutylammonium. In an embodiment where more than one counter-ion is used to balance the overall charge, the counter-ions can be mixed. For example, a metal ion chelate complex requiring two positive charges may have one positive charge supplied by sodium and the other by potassium.

The properties of the density gradient may be modified by choosing different combinations of metal ions, chelating agents and counter ions. Examples of metal ion chelate complexes suitable for use in the present disclosure include, but are not limited to NaCuEDTA, NaFeEDTA, NaBiEDTA, Cs₂CdEDTA and CsBiEDTA. It is contemplated that solutions of more than one metal ion chelate complex can also be used to form density gradients. The concentration of the metal ion chelate complex may generally be any suitable concentration. In the embodiment of FIG. 1, the concentration of the metal ion chelate complex solution is from about 0.01 M to about 0.7 M, alternatively, from about 0.1 M to about 0.3 M. In an embodiment, a lower concentration may generally result in a lower density range while a more concentrated solution may generally yield a higher density range.

In an embodiment, the unseparated solution further comprises a buffer. Examples of suitable buffers include but are not limited to phosphate, acetate, and tris(hydroxymethyl)aminomethane (“Tris”). The buffers used herein may be chosen by one of ordinary skill in the art so as to be compatible with the methodolgies disclosed herein. In an embodiment, the buffer is chosen so as to provide a pH in the range of from about 3.5 to about 8.5, alternatively from about 4.0 to about 8.0, alternatively from about 4.5 to about 7.5. Additional disclosure on metal ion chelate complexes suitable for use in this disclosure can be found in U.S. Pat. Nos. 6,753,185; 6,593,145 and 7,320,893 each of which is incorporated by reference herein in its entirety.

In an embodiment, the unseparated solution is separated by forming a density gradient. In an embodiment, separating serum into lipoprotein subclasses comprises mixing the serum with the DGFS in a centrifuge tube or other container and applying a centrifugal force. It is contemplated that different rotor sizes, shapes, and compositions as well as sample tubes of different sizes, shapes, and compositions may be employed.

A centrifugal force may be applied to the solution by spinning the tube in a rotor. Any of the suitable rotor/tube configurations known in the art may be used with the density gradients of the present disclosure. Examples include, but are not limited to fixed angle rotors, vertical tube rotors and swinging bucket rotors. In a particular embodiment, the rotor configuration comprises a fixed angle ranging from about 15 degrees to about 45 degrees, alternatively, about 30 degrees.

The centrifugal force may generally be any strength sufficient to separate the lipoprotein subclasses. In various embodiments, the force field is at least about 400,000×g, alternatively, about 400,000×g to about 600,000×g, alternatively, about 500,000×g to about 550,000×g. As will be appreciated by those of skill in the art, the spin rate may affect the speed at which the density gradient is formed, a faster spin rate typically resulting in faster gradient formation. In embodiments, rapid gradient formation may be desirable where a reduced time for separation is desired. However, too rapid of a gradient formation may adversely affect particle separation in that the particles do not have a chance to find their isopycnic point before the gradient becomes too steep.

The properties of the density gradient are a function of a variety of factors such as the particular metal ion chelate complex employed, the concentration of the solution, temperature and the magnitude of the centrifugal field. The density gradient formed may be an essentially exponential density gradient. By exponential density gradient, it is meant that the density of the solution varies essentially exponentially as a function of position from one end of the tube to the other. Generally, exponential geometry of a density gradient is an indication that the gradient is at equilibrium. A density gradient is a suitable means of attaining isopycnic mode separations wherein the particles migrate through the gradient until they reach a position that is equal to their own density. In embodiments, isopycnic mode separations are desirable because they reflect the true equilibrium densities of the particles. Isopycnic mode separations are particularly suitable for the analysis of lipoproteins because the isopycnic mode yields substantial information about the equilibrium density of the lipoproteins. This information may be relevant as a clinical diagnostic for CVD.

Without wishing to be limited by theory, separation of the biological sample into lipoprotein subclasses as described herein is accomplished by the subjecting the biological sample to a diffusive force. The diffusive force arises due to the density gradient and is always directed towards the center of the rotor (i.e., centrifuge). The sedimenting particles (i.e., various subclasses of lipoproteins) will sediment away from the rotor until their density is equivalent to the local density of the density gradient which was formed, at which point the diffusive force is equivalent to the centrifugal force. As such, the separated solution will comprise one or more “bands,” each band comprising a lipoprotein subclass separated from other lipoprotein subclasses on the basis of density. The relative densities of these lipoprotein subclasses are shown in Table 1:

TABLE 1

| LIPOPROTEIN | DENSITY KG/L |
|---|---|
| bTRL | <1.00 |
| dTRL | 1.000-1.019 |
| LDL-1 | 1.019-1.023 |
| LDL-2 | 1.023-1.029 |
| LDL-3 | 1.029-1.039 |
| LDL-4 | 1.039-1.050 |
| LDL-5 | 1.050-1.063 |
| HDL-2b | 1.063-1.091 |
| HDL-2a | 1.091-1.110 |
| HDL-3a | 1.110-1.133 |
| HDL-3b | 1.133-1.156 |
| HDL-3c | 1.156-1.179 |

The biological samples can generally comprise any lipoprotein subclass. A separated mixture may contain one or more of these subclasses, depending on the composition of the biological sample. The biological samples may also comprise remnant lipoproteins, oxidized lipoproteins, and inflammatory markers. Such components may also be detectable by the methodologies described herein.

In an alternative embodiment, separating the lipoprotein subclasses of the serum may be carried out using any suitable process. Such processes are known in the art and include, but are not limited to gradient gel eletrophoresis, capillary electrophoresis, ultracentrifugation-vertical auto profiling, tube gel electrophoresis, chromatography, or combinations thereof. The unseparated solution having been subjected to the separation processes disclosed herein is termed the “separated solution.”

In an embodiment, the lipoprotein profile of the biological sample is determined by identifying and quantifying the lipoprotein subclasses present in the separated solution. In an embodiment, lipoprotein subclasses are observed using any suitable technique such as dyes, stains, fluorescent markers, Rayleigh scattering, computer enhancement, differential density profiling, fluorescent antibodies, and natural fluorescence or combinations thereof. Further visualization of markers associated with a lipoprotein subclass may comprise the use of any excitation source including halide lamps, lasers, etc and any modification to said source. Quantification of the lipoprotein subclasses may be made using any suitable methodology such as photography, videography, microscopy, nuclear magnetic resonance imaging, computer scanning, human visualization, or combinations thereof.

In an embodiment, a method of quantifying the lipoprotein subclasses comprises imaging the separated solution. Generally, the separated solution may be imaged using any suitable means, examples of which include but are not limited to scanning a spectrophotometer image of the separated mixture or photographing the separated mixture.

The photograph or scanned image (hereinafter the image) may be digitized in a computer and analyzed. For example analysis of the image may comprise converting the image into a particle density profile. Methods of converting the image into a particle density profile are known to one of ordinary skill in the art and any suitable method may be employed. For example, converting the image into a particle density profile may comprise determining the intensity of one or more of the bands within the separated solution (e.g., using refractive index, gravimetry, and/or UV-absorbance of the band). The particle density profile may express the intensity of at least a portion of the bands occurring on the image. Not seeking to be bound by theory the intensity of a given band as compared to the cumulative intensity of all bands in the separated solution will be approximately proportionate to the quantity of the lipoprotein within the individual band as compared to the total quantity of lipoproteins present in the separated solution. As such, by ascertaining the relative intensity of a band (e.g., as via imaging the separated solution) the relative concentration of lipoprotein represented by that band may be calculated. Consequently, if the total quantity of lipoprotein in the biological sample is known, the quantity of lipoprotein in a given band may be calculated.

In an embodiment, particular regions of interest may be selected and isolated from the ultracentrifuge tube using a freeze, cut, and thaw method. For example, the VLDL, LDL, and/or HDL fractions can be isolated and analyzed for cholesterol and triglyceride levels using standard analytical assays. Alternatively, aliquots of the fractions can be withdrawn by pipetting at specific density locations in the ultracentrifuge tube.

In embodiments, isolated lipoprotein subclasses may subsequently be analyzed by a variety of methods nonlimiting examples of which include capillary electrophoresis, solid phase extraction, mass spectrometry, thin layer chromatography, electron paramagnetic resonance, immobilized pH gradient isoelectric focusing, matrix assisted laser desorption/ionization (MALDI) mass spectrometry, electrospray ionization mass spectrometry (ESI-MS), and two dimensional gel electrophoresis.

In an embodiment, the lipoprotein profile may be determined as described herein for a biological sample under a plurality of conditions. For example, a plurality of biological samples may be obtained from a member of the population subset as a function of time to monitor changes in the lipoprotein profile. The processes disclosed herein may afford the monitoring of a member of the population subset occurrence and/or risk for CVD due to various factors such as medication, exercise, diet, age, or combinations thereof.

In an embodiment, the DCD 1000 and the DRA 2000 further comprise determining a correlative between the one or more attributes of the biological sample and the DOI 500. The correlative may be determined using a statistical method to define a mathematical relationship between the one or more attributes derived from the biological sample and the DOI. In an embodiment, the statistical method is employed to define an approximately linear relationship between the one or more attributes derived from the biological sample and the DOI. In an embodiment, the statistical method employed is a statistical classification modeling method. Nonlimiting examples of statistical classification modeling methods suitable for use in this disclosure include linear discrimination analysis (LDA), recursive partitioning (RP), sliced average variance estimation (SAVE), sliced mean variance covariance (SMVCIR), or combinations thereof. In an embodiment statistical classification modeling is applied to the quantifiable data obtained from the biological samples which may comprise bTRL, dTRL, LDL-1, LDL-2, LDL-3, LDL-4, LDL-5, HDL-2b, HDL-2a, HDL-3b, HDL-3c, APOC1HDL, TC, LDL-C, HDL-C, TG. In an alternative embodiment, statistical classification modeling is applied to quantifiable data that has been subjected to one or more mathematical transformations. For example, the quantifiable data may be utilized in the statistical classification method as a logarithmic value and/or as the percentage contribution of the variable of interest to the totality of variables investigated.

LDA is a statistical method by which Linear classification algorithms, which represent a large portion of the available techniques, are based on fitting a linear discriminant function to the data. This linear decision is of the form f(x)=wx+b where b is the bias and w the normal vector to the decision boundary f(x)−0. One approach to fit this linear function to the data is Linear Discriminant Analysis which amounts to fitting a Gaussian probabilistic model to the data. In its simplest formulation, assuming the feature vector x has a Gaussian distribution with different class conditional means [Xj and \i2 for class 1 and 2 respectively and the same covariance matrix H1−22=2 in the two cases, the optimal decision function in a Bayesian framework is of the form:

$$\text{?} ( x ) = ( {μ}_{1} - {μ}_{2} ) \text{?} ( x - \frac{{μ}_{1} + {μ}_{2 }}{2} ) = \text{?} x + \text{?}$$

$$\text{?} \text{indicates text missing or illegible when filed}$$

SAVE is a statistical method which does not require the specification of a model in order to estimate a linear combination of attributes. SAVE is the most inclusive among dimension reduction methods as it gains information from both the inverse mean function and the differences of the inverse covariances.

SMVCIR is a statistical method based on searching for linear combinations of the predictor variables which best separate the groups in terms of mean, variance and covariance of these linear combinations.

Recursive partitioning (RP) is a data mining tool. When RP makes the first sweep through attributes (e.g., lipoprotein subclasses) it tries to identify those attributes that result in a significant association with the DOI (e.g., CVD). The data are then divided into subgroups corresponding to selected attribute categories, and the association test is repeated in the subgroups using the remaining attributes. At this stage the interaction can be detected.

In an embodiment, the methodologies disclosed herein establish a correlative between an attribute of the biological sample and the DOI using a statistical classification modeling method. As used herein, the “correlative” refers to the combination of attributes that distinguish one group from another. In other words the correlative serves as a mechanism of classification and utilizes the attributes of the biological sample to assign membership of the individual to a particular group.

In an embodiment, the population comprises humans and the population subset comprises organisms having CVD. The lipoprotein profile of the population subset may be subjected to a statistical classification methodology of the type previously described herein. The resulting correlative is an approximately linear combination between two or more lipoprotein subclasses and the DOI. The correlative may be predictive for an individual's membership within the population subset as the correlative may be determined to be valid for a majority of members of the population subset.

In an embodiment, the correlative comprises a relationship between a plurality of lipoprotein subclasses and CVD. In an additional embodiment, the correlative further comprises a relationship between a plurality of lipoprotein subclasses and one or more other characteristics. Nonlimiting examples of such other characteristics includes, age, hypertension, hyperlipidemia, family history, gender, tobacco use, alcohol use, other health related factors, or combinations thereof. Correlatives defining an approximately linear relationship between lipoprotein profiles and occurrence and/or risk for developing CVD are described in greater detail below.

In an embodiment, the calculated correlative (C) comprises a mathematical relationship between a TC fraction, an HDL fraction, an LDL fraction, and a TG fraction. It is to be understood in the equations to follow the exponents are given a two symbol alpha-numeric designation. The numeric portion is not to be considered as a multiplier of the value denoted by the alphabetic portion. In other words, the exponent 5m is given values as described in the specification. It is not to be construed as the value obtained by multiplying the variable m by five. Further, the mathematical relationship may lead to quantifiable data which can be used to determine an individual's membership in a given population subset.

In an embodiment, C comprises the mathematical relationship expressed in Equation (1), or approximations of the same:

$${C}_{1} = \frac{{TC}^{1 a}}{{HDL}^{1 b} \times {LDL}^{1 c} \times {TG}^{1 d}} \qquad Equation ( 1 )$$

where 1a is about 1; where 1b is about 0.30 to about 0.40, alternatively about 0.33 to about 0.37, alternatively, about 0.35; where 1c is 0 to about 0.35, alternatively, 0.23 to about 0.27, alternatively, about 0.25; and where 1d is about 0 to about 0.08, alternatively, about 0.02 to about 0.06, alternatively, about 0.04. In a particular embodiment, the correlative comprises the mathematical relationship expressed in Equation (1_{β}) or approximations of the same:

$${C}_{1 β} = \frac{TC}{{HDL}^{0.35} \times {LDL}^{0.25} \times {TG}^{0.04}} \qquad Equation ( {1}_{β} )$$

In an additional embodiment, the correlative (C) comprises a simplified expression of the mathematical relationship of Equation (1), or approximations of the same, expressed as Equation (1γ):

$${C}_{1} γ = \frac{TC}{{HDL}^{0.35}} \qquad Equation ( 1 γ )$$

In an alternative embodiment, the correlative (C) comprises the mathematical relationship expressed in Equation (2), or approximations of the same:

$${C}_{2} = \frac{{HDL}^{2 a} \times {LDL}^{2 b} \times {TG}^{2 c}}{{TC}^{2 d}} \qquad Equation ( 2 )$$

where 2a is about 0.24 to about 0.39, alternatively about 0.27 to about 0.31, alternatively, about 0.29; where 2b is 0 to about 0.14, alternatively, 0.07 to about 0.11, alternatively, about 0.09; where 2c is 0 to about 0.16, alternatively, about 0.09 to about 0.13, alternatively, about 0.11; and where 2d is about 1. In a particular embodiment, the correlative comprises the mathematical relationship expressed in Equation (2a) or approximations of the same:

$${C}_{2 α} = \frac{{HDL}^{0.29} \times {LDL}^{0.09} \times {TG}^{0.11}}{TC} \qquad Equation ( 2 α )$$

In an additional embodiment, the correlative (C) comprises a simplified expression of the mathematical relationship of Equation (2), or approximations of the same, expressed as Equation (2_{β}):

$${C}_{2 β} = \frac{{HDL}^{0.29}}{TC} \qquad Equation ( {2}_{β} )$$

In an alternative embodiment, the correlative (C) comprises the mathematical relationship expressed in Equation (3), or approximations of the same:

$${C}_{3} = \frac{{HDL}^{3 a} \times {LDL}^{3 b} \times {TG}^{3 c}}{{TC}^{3 d}} \qquad Equation ( 3 )$$

where 3a is about 0.49 to about 0.69, alternatively about 0.57 to about 0.61, alternatively, about 0.59; where 3b is about 0.44 to about 0.54, alternatively, 0.47 to about 0.51, alternatively, about 0.49; where 3c is 0 to about 0.06, alternatively, about 0.02 to about 0.04, alternatively, about 0.11; and where 3d is about 1. In a particular embodiment, the correlative comprises the mathematical relationship expressed in Equation (3_{α}) or approximations of the same:

$${C}_{3 α} = \frac{{HDL}^{0.59} \times {LDL}^{0.49} \times {TG}^{0.03}}{TC} \qquad Equation ( {3}_{α} )$$

In an additional embodiment, the correlative (C) comprises a simplified expression of the mathematical relationship of Equation (3), or approximations of the same, expressed as Equation (3_{β}):

$${C}_{3 β} = \frac{{HDL}^{0.59} \times {LDL}^{0.49}}{TC} \qquad Equation ( {3}_{β} )$$

In an alternative embodiment, the correlative (C) comprises an expression of a mathematical relationship between an HDL fraction, an LDL-5 fraction, an HDL-2b fraction, and an HDL-3c fraction. In an embodiment, the correlative comprises the mathematical relationship expressed in Equation (4), or approximations of the same:

$${C}_{4} = \frac{\begin{matrix}HDL \text{-} 3 {b}^{4 a} \times LDL \text{-} {5}^{4 b} \times {HDL}^{4 c} \times \\ LDL \text{-} {3}^{4 d} \times HDL \text{-} 2 {a}^{4 e} \times LDL \text{-} {2}^{4 f}\end{matrix}}{\begin{matrix}HDL \text{-} 2 {b}^{4 g} \times HDL \text{-} 3 {c}^{4 h} \times HDL \text{-} 3 {a}^{4 j} \times \\ LDL \text{-} {4}^{4 k} \times {dTRL}^{4 m} \times \\ {bTRL}^{4 n} \times LDL \text{-} {1}^{4 p} \times {Age}^{4 q}\end{matrix}} \qquad Equation ( 4 )$$

where 4a is about 1; where 4b is about 0.72 to about 0.82, alternatively about 0.75 to about 0.79, alternatively, about 0.77; where 4c is about 0.50 to about 0.60, alternatively, 0.53 to about 0.57, alternatively, about 0.55; where 4d is 0 to about 0.37, alternatively, about 0.32; where 4e is 0 to about 0.14, alternatively, about 0.09; where 4f is from 0 to about 0.12, alternatively, about 0.07, where 4g is about 0.88 to about 0.98, alternatively, about 0.91 to about 0.95, alternatively, about 0.93; and where 4h is about 0.72 to about 0.82, alternatively about 0.75 to about 0.79, alternatively, about 0.77; where 4j is 0 to about 0.43, alternatively, about 0.37; where 4k is 0 to about 0.43, alternatively, about 0.37; where 4m is 0 to about 0.22, alternatively, about 0.17; where 4n is 0 to about 0.22, alternatively, about 0.17; where 4p is 0 to about 0.08, alternatively, about 0.03; and where 4q is 0 to about 0.05, alternatively, about 0.01. In a particular embodiment, the correlative comprises the mathematical relationship expressed in Equation (4A) or approximations of the same:

$${C}_{4 α} = \frac{\begin{matrix}HDL \text{-} 3 b \times LDL \text{-} {5}^{0.77} \times {HDL}^{0.55} \times LDL \text{-} {3}^{0.32} \times \\ HDL \text{-} 2 {a}^{0.09} \times LDL \text{-} {2}^{0.07}\end{matrix}}{\begin{matrix}HDL \text{-} 2 {b}^{0.93} \times HDL \text{-} 3 {c}^{0.77} \times HDL \text{-} 3 {a}^{0.37} \times \\ LDL \text{-} {4}^{0.37} \times {dTRL}^{0.17} \times {bTRL}^{0.17} \times \\ LDL \text{-} {1}^{0.03} \times {Age}^{0.01}\end{matrix}} \qquad Equation ( {4}_{α} )$$

In an additional embodiment, the correlative (C) comprises a simplified expression of the mathematical relationship of Equation (4), or approximations of the same, expressed as Equation (4_{β}):

$${C}_{4 β} = \frac{HDL \text{-} 3 b \times LDL \text{-} {5}^{0.77} \times {HDL}^{0.55}}{HDL \text{-} 2 {b}^{0.93} \times HDL \text{-} 3 {c}^{0.77}} \qquad Equation ( {4}_{β} )$$

In an alternative embodiment, the C comprises an expression of a mathematical relationship between an HDL-2b fraction, an LDL-4 fraction, an HDL-2a fraction, an LDL-5 fraction, and an HDL fraction. In an embodiment, the C comprises the mathematical relationship expressed in Equation (5), or approximations of the same:

$${C}_{5} = \frac{\begin{matrix}HDL \text{-} 2 {b}^{5 a} \times LDL \text{-} {4}^{5 b} \times {HDL}^{5 c} \times LDL \text{-} {2}^{5 d} \times \\ LDL \text{-} {1}^{5 e} \times HDL \text{-} 3 {c}^{5 f} \times {bTRL}^{5 g}\end{matrix}}{\begin{matrix}HDL \text{-} 2 {a}^{5 h} \times LDL \text{-} {5}^{5 j} \times LDL \text{-} {3}^{5 k} \times {Age}^{5 m} \times \\ {dTRL}^{5 n} \times HDL \text{-} 3 {c}^{5 p} \times HDL \text{-} 3 {b}^{5 q}\end{matrix}} \qquad Equation ( 5 )$$

where 5a is about 1; where 5b is about 0.38 to about 0.48, alternatively about 0.41 to about 0.45, alternatively, about 0.43; where 5c is 0 to about 0.23, alternatively, about 0.18; where 5d is 0 to about 0.18, alternatively, about 0.13; where 5d is 0 to about 0.18, alternatively, about 0.13; where 5f is 0 to about 0.13, alternatively, about 0.08; where 5g is 0 to about 0.08, alternatively, about 0.03; where 5h is about 0.82 to about 0.92, alternatively, 0.85 to about 0.89, alternatively, about 0.87; where 5j is about 0.60 to about 0.70, alternatively, about 0.63 to about 0.67, alternatively, about 0.65; 5k is 0 to about 0.24, alternatively, about 0.19; where 5m is 0 to about 0.21, alternatively, about 0.16; where 5n is 0 to about 0.16, alternatively, about 0.11; where 5p is 0 to about 0.14, alternatively, about 0.09; and where 5q is 0 to about 0.09, alternatively, about 0.04. In a particular embodiment, the correlative comprises the mathematical relationship expressed in Equation (5A) or approximations of the same:

$${C}_{5 α} = \frac{\begin{matrix}HDL \text{-} 2 b \times LDL \text{-} {4}^{0.43} \times {HDL}^{0.18} \times LDL \text{-} {2}^{0.13} \times \\ LDL \text{-} {1}^{0.13} \times HDL \text{-} 3 {c}^{0.08} \times {bTRL}^{0.03}\end{matrix}}{\begin{matrix}HDL \text{-} 2 {a}^{0.87} \times LDL \text{-} {5}^{0.65} \times LDL \text{-} {3}^{0.19} \times \\ {Age}^{0.16} \times {dTRL}^{0.11} \times HDL \text{-} 3 {c}^{0.09} \times HDL \text{-} 3 {b}^{0.04}\end{matrix}} \qquad Equation ( {5}_{α} )$$

In an additional embodiment, the correlative (C) comprises a simplified expression of the mathematical relationship of Equation (5), or approximations of the same, expressed as Equation (5_{β}):

$${C}_{5 β} = \frac{HDL \text{-} 2 b \times LDL \text{-} {4}^{0.43}}{HDL \text{-} 2 {a}^{0.87} \times DL \text{-} {5}^{0.65}} \qquad Equation ( {5}_{β} )$$

In an alternative embodiment, the correlative (C) comprises an expression of a mathematical relationship between an HDL-3b fraction, an HDL-3c fraction, an HDL-2a fraction, an LDL-2a fraction, an LDL-2 fraction, LDL-3 fraction, and an LDL-5 fraction. In an embodiment, the correlative comprises the mathematical relationship expressed in Equation (6), or approximations of the same:

$${C}_{6} = \frac{\begin{matrix}HDL \text{-} 3 {b}^{6 a} \times HDL \text{-} 3 {c}^{6 b} \times HDL \text{-} 2 {a}^{6 c} \times LDL \text{-} {2}^{6 d} \times \\ {bTRL}^{6 e} \times {HDL}^{6 f} \times LDL \text{-} {4}^{6 g} \times HDL \text{-} 3 {a}^{6 h} \times {dTRL}^{6 j}\end{matrix}}{\begin{matrix}LDL \text{-} {3}^{6 k} \times LDL \text{-} {5}^{6 m} \times {Age}^{6 n} \times \\ HDL \text{-} 2 {b}^{6 p} \times LDL \text{-} {1}^{6 q}\end{matrix}} \qquad Equation ( 6 )$$

where 6a is about 1; where 6b is about 0.70 to about 0.80, alternatively about 0.73 to about 0.77, alternatively, about 0.75; where 6c is about 0.56 to about 0.66, alternatively, 0.59 to about 0.63, alternatively, about 0.61; where 6d is about 0.36 to about 0.46, alternatively, about 0.39 to about 0.43, alternatively, about 0.41; where 6e is 0 to about 0.25, alternatively, about 0.20; where 6f is 0 to about 0.24, alternatively, about 0.19; where 6g is 0 to about 0.21, alternatively, about 0.16; where 6h is 0 to about 0.14, alternatively, about 0.09; where 6j is 0 to about 0.07, alternatively, about 0.02; where 6k is about 0.46 to about 0.56, alternatively, about 0.49 to about 0.53, alternatively, about 0.51; where 6m is about 0.37 to about 0.47, alternatively, about 0.40 to about 0.44, alternatively, about 0.42; where 6n is 0 to about 0.44, alternatively, about 0.39; where 6p is 0 to about 0.42, alternatively, about 0.37; and where 6q is 0 to about 0.34, alternatively, about 0.29. In a particular embodiment, the correlative comprises the mathematical relationship expressed in Equation (6_{α}) or approximations of the same:

$${C}_{6 α} = \frac{\begin{matrix}HDL - 3 b \times HDL - 3 {c}^{0.75} \times HDL - 2 {a}^{0.61} \times \\ LDL - {2}^{0.41} \times {bTRL}^{0.20} \times {HDL}^{0.19} \times \\ LDL - {4}^{0.16} \times HDL - 3 {a}^{0.09} \times {dTRL}^{0.02}\end{matrix}}{\begin{matrix}LDL - {3}^{0.51} \times LDL - {5}^{0.42} \times \\ {Age}^{0.39} \times HDL - 2 {b}^{0.37} \times LDL - {1}^{0.29}\end{matrix}} \qquad Equation ( {6}_{α} )$$

In an additional embodiment, the correlative (C) comprises a simplified expression of the mathematical relationship of Equation (6), or approximations of the same, expressed as Equation (6_{β}):

$${C}_{6 β} = \frac{\begin{matrix}HDL - 3 b \times HDL - 3 {c}^{0.75} \times \\ HDL - 2 {a}^{0.61} \times LDL - {2}^{0.41}\end{matrix}}{LDL - {3}^{0.51} \times LDL - {5}^{0.42}} \qquad Equation ( {6}_{β} )$$

In an alternative embodiment, the correlative (C) comprises an expression of a mathematical relationship between an HDL-3b fraction, an LDL-2 fraction, an HDL-3c fraction, and LDL-3 fraction. In an embodiment, the correlative comprises the mathematical relationship expressed in Equation (7), or approximations of the same:

$${C}_{7} = \frac{\begin{matrix}HDL - 3 {b}^{7 a} \times LDL - {2}^{7 b} \times LDL - {4}^{7 c} \times \\ {Age}^{7 d} \times LDL - {1}^{7 e} \times {HDL}^{7 f}\end{matrix}}{\begin{matrix}HDL - 3 {c}^{7 g} \times LDL - {3}^{7 h} \times HDL - 3 {a}^{7 j} \times \\ {bTRL}^{7 k} \times {dTRL}^{7 m} \times HDL - 2 {b}^{7 n} \times \\ LDL - {5}^{7 p} \times HDL - 2 {a}^{7 q}\end{matrix}} \qquad Equation ( 7 )$$

where 7a is about 1; where 7b is about 0.55 to about 0.65, alternatively about 0.58 to about 0.62, alternatively, about 0.60; where 7c is 0 to about 0.44, alternatively about 0.39; where 7d is 0 to about 0.22, alternatively, about 0.17; where 7e is 0 to about 0.09, alternatively, about 0.04; where 7f is 0 to about 0.08, alternatively, about 0.03; where 7g is about 0.78 to about 0.88, alternatively, 0.81 to about 0.85, alternatively, about 0.83; where 7h is about 0.51 to about 0.61, alternatively, about 0.54 to about 0.58, alternatively, about 0.56; where 7j is 0 to about 0.42, alternatively, about 0.37; where 7k is 0 to about 0.27, alternatively, about 0.22; where 7m is 0 to about 0.16, alternatively, about 0.11; where 7n is 0 to about 0.14, alternatively, about 0.09; where 7p is 0 to about 0.10, alternatively, about 0.05; and where 7q is 0 to about 0.06, alternatively, about 0.01. In a particular embodiment, the correlative comprises the mathematical relationship expressed in Equation (7_{α}) or approximations of the same:

$${C}_{7 α} = \frac{\begin{matrix}HDL - 3 b \times LDL - {2}^{0.60} \times LDL - {4}^{0.39} \times \\ {Age}^{0.17} \times LDL - {1}^{0.04} \times {HDL}^{0.03}\end{matrix}}{\begin{matrix}HDL - 3 {c}^{0.83} \times LDL - {3}^{0.56} \times HDL - 3 {a}^{0.37} \times \\ {bTRL}^{0.22} \times {dTRL}^{0.11} \times HDL - 2 {b}^{0.09} \times \\ LDL - {5}^{0.05} \times HDL - 2 {a}^{0.01}\end{matrix}} \qquad Equation ( {7}_{α} )$$

In an additional embodiment, the correlative (C) comprises a simplified expression of the mathematical relationship of Equation (7), or approximations of the same, expressed as Equation (7_{β}):

$${C}_{7 β} = \frac{HDL - 3 b \times LDL - {2}^{0.60}}{HDL - 3 {c}^{0.83} \times LDL - {3}^{0.56}} \qquad Equation ( {7}_{β} )$$

Returning to FIG. 2, in an embodiment, the DRA 2000 comprises obtaining a biological sample from a subject 600. In an embodiment, the subject is a human whose risk for the development of CVD is to be assessed. The biological sample may be of the type previously described herein. In an embodiment, the biological sample obtained from the subject will be the same type of biological sample obtained from the members of the population subset used to determine the correlative. Further, the biological sample may be obtained from the subject via any suitable means or process as previously disclosed herein.

In an embodiment, the DRA 2000 comprises deriving one or more attributes for the subject biological sample 700. For example, the lipoprotein profile of the subject may be determined as described previously herein.

In an embodiment, the DRA 2000 comprises predicting whether the subject is a member of the population subset 800. Predicting whether the subject is a member of the population subset 800 generally comprises employing a correlative to ascertain whether one or more attributes of the subject biological sample bear the same or about the same relationship as the attributes derived from biological samples obtained from the population subset.

Not intending to be limited by theory, those of skill in the art may theorize that where the relationship between one or more of the attributes obtained from a biological sample obtained from a subject is approximated by a correlative, the subject would be expected to be a member of the group used to derive that correlative. Alternatively, where the relationship between one or more of the attributes derived from a biological sample obtained from a subject is not approximated by a correlative, the subject would not be expected to be a member of the group used to derive that correlative.

In an embodiment, a subject has a relationship among the lipoprotein subclasses which is approximated by the correlative determined for the population subset comprising humans established to have CVD. In such an embodiment, the subject would be characterized as having CVD. Alternatively, a subject having a relationship among the lipoprotein subclasses which is approximated by the correlative determined for the population subset comprising humans not having CVD may be characterized as not having CVD.

In an embodiment, a subject having a relationship among the lipoprotein subclasses which is approximated by the correlative determined for the population subset comprising humans at risk for developing CVD may be characterized as at risk for developing CVD.

In an embodiment, the methodologies disclosed herein are equal to or greater than about 85% effective in classifying membership of an individual subject in a population subset. Alternatively equal to or greater than about 90, 95, 97.5, 99, 99.5 or 100% effective in classifying membership of an individual subject in a population subset. In an embodiment, classification of a subject comprises determining the membership of the subject in a group wherein membership in the group is based on a health related issue. For example, the classification of the subject as described herein may result in the subject being classified as a member of a population subset at risk for developing CVD. In an embodiment, the methodologies disclosed herein are employed to develop methods of classifying subjects into groups wherein membership is based on the presence, absence, or risk for development of a disease. In such an embodiment, the methodologies disclose herein are equal to or greater than about 85% effective in identifying issues concerning the individual's health.

Although specific embodiments related to classification of subjects based on relationships between lipoprotein profile and CVD have been described, it is contemplated the disclosed methodologies may be employed for classification of subjects based on relationships between lipoprotein profile and other DOIs. In an embodiment, the methodologies disclosed herein may be utilized for any disease (e.g., genetic disorders, coronary heart disease) wherein lipoprotein type and amount may influence the onset, progression and/or outcome of the disease. In an embodiment, the methodologies disclosed may be used to identify subjects at risk or experiencing a form of diabetes and/or suffering from metabolic syndrome. In another embodiment, the methodologies disclosed herein may be employed for establishing relationships between attributes of a biological sample obtained from a subject and a DOI.

In an embodiment, all or some portion of a DCD or a DRA may be automated. In an embodiment, all or some portion of such a DCD or DRA is implemented in software on a computer or other computerized component having a processor, user interface, microprocessor, memory, and other associated hardware and operating software. Software implementing the preparation of a theoretical diffraction pattern may be stored in tangible media and/or may be resident in memory on the computer. Likewise, input and/or output from the software, for example ratios, comparisons and results may, be stored in a tangible media, computer memory, hardcopy such a paper printout, or other storage device.

Alternatively, in an embodiment, all or some portion of a DCD or a DRA may be performed manually, for example, as by a clinician or other person. Alternatively, some portion of a DCD or a DRA is performed manually and some portion is automated.

### EXAMPLES

These examples describe the analysis of data on a number of variables that were provided for 18 control patients and 14 patients with CVD. An aim of this analysis was to understand how attributes of these variables differ across the two groups of patients. In these examples, LDA, SAVE, RP, and SMVCIR was employed as a classification models. The SAVE and SMVCIR approaches to classification are based on searching for linear combinations of the predictor variables which best separate the groups in terms of mean, variance and covariance of these linear combinations. Further, it is to be understood that the Figures presented are graphical representations of the quantifiable data or mathematically transformed values thereof during various stages of development of the methodologies disclosed herein. Discrepancies in the graphical representation of similar or identical data sets subjected to the methodologies disclosed herein may be reflective of evolutions of the underlying formulae utilized in the statistical classification method and further such variations would be understood by one of ordinary skill in the art with the benefits of this disclosure.

### Example 1

The lipoprotein profile with respect to TC, HDL, LDL, TG were analyzed using LDA and SAVE. Specifically the relative amounts of these lipoprotein subclasses were determined using the methodologies described herein and are denoted the attributes of the sample. All attributes were log-transformed; that is, the attributes used in LDA and SAVE were log-transformed versions of the attributes.

In a two group problem, LDA seeks to find a linear combination of the predictor variables which best separates the two groups in terms of the mean of this linear combination. Given below are the results obtained from LDA using these four variables as predictors. Based on cross-validation, we find that LDA based on these two predictors correctly classifies 81.3% of the 32 cases as either CVD or control. For the current data set, the most important variable in the LDA linear combination was found to be log(TC).

The linear combination obtained from LDA is expressed as:

$$\begin{matrix} = 8.21 log ( TC ) - 2.87 log ( HDL ) - 2.05 log ( LDL ) - 0.328 log ( TG ) \\ = 8.21 [ log ( TC ) - {log ( HDL )}^{2.87 / 8.21} - {log ( LDL )}^{2.05 / 8.21} - \\ {log ( TG )}^{0.328 / 8.21} ] \\ = 8.21 log ( \frac{TC}{{HDL}^{0.35} \times {LDL}^{0.25} \times {TG}^{0.04}} )\end{matrix}$$

Thus, the relevant term in LDA is proportional to:

$$\frac{TC}{{HDL}^{0.35} \times {LDL}^{0.25} \times {TG}^{0.04}} .$$

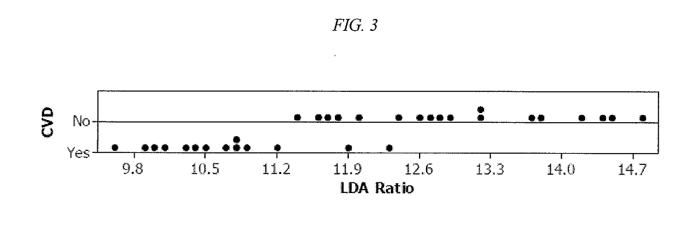

FIG. 3 provides a plot of this ratio for these 32 data points. Thus, this straightforward ratio provides a rule by which to discriminate between the CVD and control groups. The most significant terms in this expression are:

$$\frac{TC}{{HDL}^{0.35}} .$$

Referring to FIG. 3, the LDA ratio is on average smaller for patients with CVD than it is for patients without CVD. Thus, the previous ratio is generally smaller for patients with CVD than it is for patients without CVD.

### Example 2

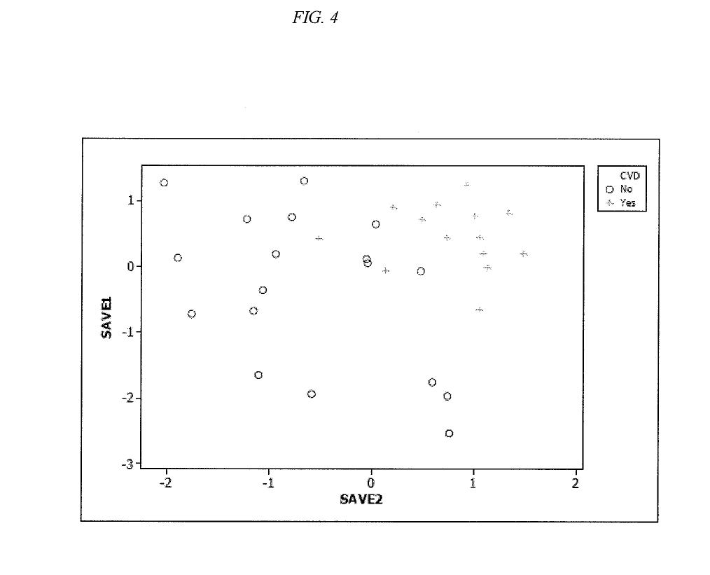

In a two group problem, SAVE1 seeks to find linear combinations of the predictor variables which best separates the two groups in terms of the mean, variance and covariance of these linear combinations. FIG. 2 shows a plot of the first two linear combinations produced by SAVE for the log-transformed attributes. It is apparent from FIG. 4 that the variability of SAVE1 differs across the two groups. On the other hand, SAVE2 splits the two groups in terms of location or means. In fact, SAVE2 and LDA are somewhat similar.

The first SAVE dimension can be approximated by

$$\begin{matrix}= - 7.66 log ( TC ) + 4.52 log ( HDL ) + 3.75 log ( LDL ) + 0.225 log ( TG ) \\ = 7.66 [ - log ( TC ) + {log ( HDL )}^{4.52 / 7.66} + {log ( LDL )}^{3.75 / 7.66} - \\ {log ( TG )}^{0.225 / 7.66} ] \\ = - 7.66 log ( \frac{{HDL}^{0.59} \times {LDL}^{0.49} \times {TG}^{0.03}}{TC} )\end{matrix}$$

Thus, the relevant term in SAVE1 is proportional to:

$$\frac{{HDL}^{0.59} \times {LDL}^{0.49} \times {TG}^{0.03}}{TC}$$

The most significant terms in this ratio are:

$$\frac{{HDL}^{0.59} \times {LDL}^{0.49}}{TC} .$$

Referring to FIG. 4, we see that SAVE1 varies less across patients with CVD than it does across patients without CVD. Thus, the previous ratio is less variable for patient with CVD than it is for patients without CVD.

### Example 3

The second SAVE dimension can be approximated by:

$$\begin{matrix}= - 5.796 log ( TC ) + 1.21 log ( HDL ) - 0.505 log ( LDL ) - 0.643 log ( TG ) \\ = 5.76 [ - log ( TC ) + {log ( HDL )}^{1.21 / 5.76} - {log ( LDL )}^{0.505 / 5.76} - \\ {log ( TG )}^{0.643 / 5.76} ] \\ = - 7.76 log ( \frac{{HDL}^{0.29} \times {LDL}^{0.09} \times {TG}^{0.11}}{TC} )\end{matrix}$$

The most important terms in this ratio are:

$$\frac{{HDL}^{0.29}}{TC} .$$

Looking back at FIG. 4, we see that SAVE2 is on average larger for patients with CVD than it is for patients without CVD. Thus, the previous ratio is generally larger for patients with CVD than it is for patients without CVD.

### Example 4

The linear combination obtained from LDA is given by:

$$\begin{matrix}= - 5.11 log ( HDL - 3 b ) + 4.75 log ( HDL - 2 b ) + 3.95 log ( HDL - 3 c ) - \\ 3.91 log ( LDL - 5 ) - 2.83 log ( HDL ) + 1.89 log ( HDL - 3 a ) + \\ 1.88 log ( LDL - 4 ) - 1.63 log ( LDL - 3 ) + 0.88 log ( dTRL ) + \\ 0.87 log ( bTRL ) - 0.44 log ( HDL - 2 a ) - 0.341 log ( LDL - 2 ) + \\ 0.15 log ( LDL - 1 ) + 0.05 log ( Age ) \\ = - 5.11 [ log ( HDL 3 - b ) - {log ( HDL - 2 b )}^{0.93} - {log ( HDL - 3 c )}^{0.77} + \\ {log ( LDL - 5 )}^{0.77} + {log ( HDL )}^{0.55} - {log ( HDL - 3 a )}^{0.37 -} {log ( LDL - 4 )}^{0.37} + \\ {log ( LDL - 3 )}^{0.32} - {log ( dTRL )}^{0.17} - {log ( bTRL )}^{0.17} + {log ( HDL - 2 a )}^{0.09} + \\ {log ( LDL - 2 )}^{.0 .07} - {log ( LDL - 1 )}^{0.03} - {log ( Age )}^{0.01} ] \\ = - 5.11 log ( \frac{\begin{matrix}HDL - 3 b \times LDL - {5}^{0.77} \times {HDL}^{0.55} \times LDL - {3}^{0.32} \times \\ HDL - 2 {a}^{0.09} \times LDL - {2}^{0.07}\end{matrix}}{\begin{matrix}HDL - 2 {b}^{0.93} \times HDL - 3 {c}^{0.77} \times HDL - 3 {a}^{0.37} \times LDL - {4}^{0.37} \times \\ {dTRL}^{0.17} \times {bTRL}^{0.17} \times LDL - {1}^{0.03} \times {Age}^{0.01}\end{matrix}} ) \\ = 10.64 log ( HDL - 2 b ) - 9.21 log ( HDL - 2 a ) - 6.97 log ( LDL - 5 ) + \\ 4.56 log ( LDL - 4 ) - 2.06 log ( LDL - 3 ) + 1.19 log ( HDL ) - \\ 1.71 log ( Age ) + 1.44 log ( LDL - 2 ) + 1.42 log ( LDL - 1 ) - \\ 1.14 log ( dTRL ) - 0.97 log ( HDL - 3 c ) + 0.87 log ( HDL - 3 a ) - \\ 0.40 log ( HDL - 31 : ) + 0.31 log ( bTRL ) \\ = 10.64 [ log ( HDL - 2 b ) - {log ( HDL - 2 a )}^{0.87} - {log ( LDL - 5 )}^{0.65} + \\ {log ( LDL - 4 )}^{0.43} - {log ( LDL - 3 )}^{0.19} + {log ( HDL )}^{0.18} - {log ( Age )}^{0.16} + \\ {log ( LDL - 2 )}^{0.13} + {log ( LDL - 1 )}^{0.13} - {log ( dTRL )}^{0.11} 1 - \\ {log ( HDL - 3 c )}^{0.09} + {log ( HDL - 3 a )}^{0.08} - {log ( HDL - 3 b )}^{0.04} + \\ {log ( bTRL )}^{0.04} ] \\ = 10.64 log ( \frac{\begin{matrix}HDL - 2 b \times LDL - {4}^{0.43} \times {HDL}^{0.18} \times \\ LDL - {2}^{0.13} \times LDL - {1}^{0.13} \times HDL - 3 {c}^{0.08} \times {bTRL}^{0.03}\end{matrix}}{\begin{matrix}HDL - 2 {a}^{0.87} \times LDL - {5}^{0.65} \times LDL - {3}^{0.19} \times {Age}^{0.16} \times \\ {dTRL}^{0.11} \times HDL - 3 {c}^{0.09} \times HDL - 3 {b}^{0.04}\end{matrix}} )\end{matrix}$$

Thus, the relevant term in LDA is proportional to:

$$\frac{\begin{matrix}HDL \text{-} 3 b \times LDL \text{-} {5}^{0.77} \times {HDL}^{0.55} \times \\ LDL \text{-} {3}^{0.32} \times HDL \text{-} 2 {a}^{0.09} \times LDL \text{-} {2}^{0.07}\end{matrix}}{\begin{matrix}HDL \text{-} 2 {b}^{0.93} \times HDL \text{-} 3 {c}^{0.77} \times HDL \text{-} 3 {a}^{0.37} \times LDL \text{-} {4}^{0.37} \times \\ {dTRL}^{0.17} \times {bTRL}^{0.17} \times LDL \text{-} {1}^{0.03} \times {Age}^{0.01}\end{matrix}}$$

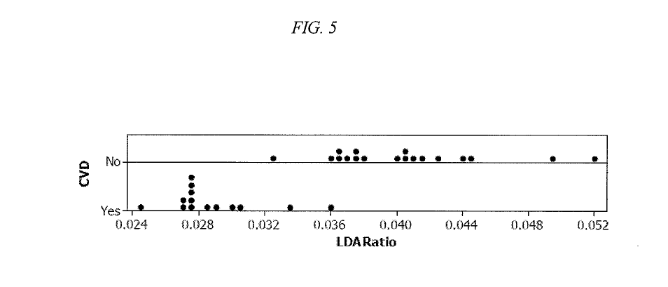

FIG. 5 provides a plot of this ratio for the 32 data points. Thus, this ratio provides a rule to discriminate between the CVD and control groups. The most significant terms in this ratio are:

$$\frac{HDL \text{-} 3 b \times LDL \text{-} {5}^{0.77} \times {HDL}^{0.55}}{HDL \text{-} 2 {b}^{0.93} \times HDL \text{-} 3 {c}^{0.77}} .$$

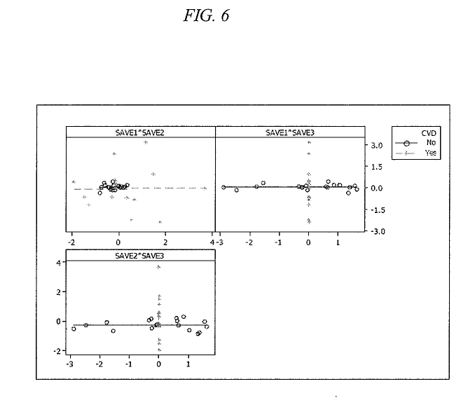

In a two group problem, SAVE seeks to find linear combinations of the predictor variables which best separates the two groups in terms of the mean, variance and covariance of these linear combinations. FIG. 6 shows a plot of the first two linear combinations produced by SAVE for the log-transformed data. It is apparent from FIG. 4 that the variability of SAVE1 and SAVE2 differs across the two groups. On the other hand, the plots SAVE3 and SAVE1 and SAVE3 and SAVE2 each produce points which lie close to two lines with different slopes. In other words, SAVE3 has found two linear combinations of the predictors whose covariance (or relationship) differs across the control and CVD groups.

### Example 5

The first SAVE dimension can be approximated by:

Thus, the relevant term in SAVE1 is proportional to:

$$\frac{\begin{matrix}HDL \text{-} 2 b \times LDL \text{-} {4}^{0.43} \times {HDL}^{0.18} \times LDL \text{-} {2}^{0.13} \times \\ LDL \text{-} {1}^{0.13} \times HDL \text{-} 3 {c}^{0.08} \times {bTRL}^{0.03}\end{matrix}}{\begin{matrix}HDL \text{-} 2 {a}^{0.87} \times LDL \text{-} {5}^{0.65} \times LDL \text{-} {3}^{0.19} \times \\ {Age}^{0.16} \times {dTRL}^{0.11} \times HDL \text{-} 3 {c}^{0.09} \times HDL \text{-} 3 {b}^{0.04}\end{matrix}} .$$

The most significant terms in this ratio are:

$$\frac{HDL \text{-} 2 b \times LDL \text{-} {4}^{0.43}}{HDL \text{-} 2 {a}^{0.87} \times DL \text{-} {5}^{0.65}} .$$

Referring to FIG. 6, we see that SAVE1 varies more across patients with CVD than it does across patients without CVD. Thus, the previous ratio is more variable for patients with CVD than it is for patients without CVD.

### Example 6

The second SAVE dimension can be approximated by

$$\begin{matrix}= 4.46 log ( HDL - 3 b ) + 3.35 log ( HDL - 3 c ) + 2.71 log ( HDL - 2 a ) - \\ 2.29 log ( LDL - 3 ) - 1.88 log ( LDL - 5 ) + 1.82 log ( LDL - 2 ) - \\ 1.76 log ( Age ) - 1.63 log ( HDL - 2 b ) - 1.28 log ( LDL - 1 ) + \\ 0.89 log ( bTRL ) + 0.87 log ( HDL ) + 0.70 log ( LDL - 4 ) + \\ 0.41 log ( HDL - 3 a ) + 0.09 log ( dTRL ) \\ = 4.46 [ log ( HDL - 3 b ) + {log ( HDL - 3 c )}^{0.75} + {log ( HDL - 2 a )}^{0.61} - \\ {log ( LDL - 3 )}^{0.51} - {log ( LDL - 5 )}^{0.42} + {log ( LDL - 2 )}^{0.41} - {log ( Age )}^{0.39} - \\ {log ( HDL - 2 b )}^{0.37} - {log ( LDL - 1 )}^{0.29} + {log ( bTRL )}^{0.20} + {log ( HDL )}^{0.19} + \\ {log ( LDL - 4 )}^{0.16} + {log ( HDL - 3 a )}^{0.09} + {log ( dTRL )}^{0.02} ] \\ = 4.46 log ( \frac{\begin{matrix}HDL - 3 b \times HDL - 3 {c}^{0.75} \times HDL - 2 {a}^{0.61} \times \\ LDL - {2}^{0.41} \times {bTRL}^{0.20} \times {HDL}^{0.19} \times \\ LDL - {4}^{0.16} \times HDL - 3 {a}^{0.09} \times {dTRL}^{0.02}\end{matrix}}{\begin{matrix}LDL - {3}^{0.51} \times LDL - {5}^{0.42} \times \\ {Age}^{0.39} \times HDL - 2 {b}^{0.37} \times LDL - {1}^{0.29}\end{matrix}} )\end{matrix}$$

Thus, the relevant term in SAVE2 is proportional to:

$$\frac{\begin{matrix}HDL \text{-} 3 b \times HDL \text{-} 3 {c}^{0.75} \times HDL \text{-} 2 {a}^{0.61} \times LDL \text{-} {2}^{0.41} \times \\ {bTRL}^{0.20} \times {HDL}^{0.19} \times LDL \text{-} {4}^{0.16} \times HDL \text{-} 3 {a}^{0.09} \times {dTRL}^{0.02}\end{matrix}}{LDL \text{-} {3}^{0.51} \times LDL \text{-} {5}^{0.42} \times {Age}^{0.39} \times HDL \text{-} 2 {b}^{0.37} \times LDL \text{-} {1}^{0.29}}$$

The most important terms in this ratio are:

$$\frac{HDL \text{-} 3 b \times HDL \text{-} 3 {c}^{0.75} HDL \text{-} 2 {a}^{0.61} LDL \text{-} {2}^{0.41}}{LDL \text{-} {3}^{0.51} LDL \text{-} {5}^{0.42}} .$$

Referring to FIG. 6, SAVE2 varies more across patients with CVD than it does across patients without CVD. Thus, the previous ratio is more variable for patients with CVD than it is for patients without CVD.

### Example 7

The third SAVE dimension can be approximated by:

$$\begin{matrix}= 6.48 log ( HDL - 3 b ) - 5.40 log ( HDL - 3 e ) + 3.89 log ( LDL - 2 ) - \\ 3.61 log ( LDL - 3 ) + 2.52 log ( LDL - 4 ) - 2.38 log ( HDL - 3 a ) - \\ 1.43 log ( bTRL ) + 1.11 log ( Age ) - 0.74 log ( dTRL ) - 0.61 log ( HDL - 2 b ) - \\ 0.29 log ( LDL - 5 ) + 0.28 log ( LDL - 1 ) + 0.21 log ( HDL ) - \\ 0.07 log ( HDL - 2 a ) \\ = 6.48 [ log ( HDL - 3 b ) - {log ( HDL - 3 c )}^{0.83} + {log ( LDL - 2 )}^{0.60} - \\ {log ( LDL - 3 )}^{0.56} + {log ( LDL - 4 )}^{0.39} - {log ( HDL - 3 a )}^{0.37} - \\ {log ( bTRL )}^{0.22} + {log ( Age )}^{0.17} - {log ( dTRL )}^{0.11} - {log ( HDL - 2 b )}^{0.09} - \\ {log ( LDL - 5 )}^{0.05} + {log ( LDL - 1 )}^{0.04} - {log ( HDL )}^{0.03} - {log ( HDL - 2 a )}^{0.01} ] \\ = 6.48 log ( \frac{\begin{matrix}HDL - 3 b \times LDL - {2}^{0.60} \times LDL - {4}^{0.39} \times \\ {Age}^{0.17} \times LDL - {1}^{0.04} \times {HDL}^{0.03}\end{matrix}}{\begin{matrix}HDL - 3 {c}^{0.83} \times LDL - {3}^{0.56} \times HDL - 3 {a}^{0.37} \times \\ {bTRL}^{0.22} \times {dTRL}^{0.11} \times HDL - 2 {b}^{0.09} \times \\ LDL - {5}^{0.05} \times HDL - 2 {a}^{0.01}\end{matrix}} )\end{matrix}$$

Thus, the relevant term in SAVE3 is proportional to:

$$\frac{\begin{matrix}HDL \text{-} 3 b \times LDL \text{-} {2}^{0.60} \times LDL \text{-} {4}^{0.39} \times \\ {Age}^{0.17} \times LDL \text{-} {1}^{0.04} \times {HDL}^{0.03}\end{matrix}}{\begin{matrix}HDL \text{-} 3 {c}^{0.83} \times LDL \text{-} {3}^{0.56} \times HDL \text{-} 3 {a}^{0.37} \times {bTRL}^{0.22} \times \\ {dTRL}^{0.11} \times HDL \text{-} 2 {b}^{0.09} \times LDL \text{-} {5}^{0.05} \times HDL \text{-} 2 {a}^{0.01}\end{matrix}}$$

The most important terms in this ratio are:

$$\frac{HDL \text{-} 3 b \times LDL \text{-} {2}^{0.60}}{HDL \text{-} 3 {c}^{0.83} \times LDL \text{-} {3}^{0.56}} .$$

Referring to FIG. 6, the relationship between SAVE 3 and SAVE1 and the relationship between SAVE 3 and SAVE 2 varies across the two groups of patients. For patients with CVD, SAVE3 is essentially the same for all values of SAVE1, while for patients without CVD, SAVE3 varies widely while SAVE1 is essentially constant. For patients without CVD, SAVE3 is essentially the same for all values of SAVE2, while for patients without CVD, SAVE3 varies widely

### Example 8

It is to be understood in the equations to follow the exponents are given a two symbol alpha-numeric designation. The numeric portion is not to be considered as a multiplier of the value denoted by the alphabetic portion. In other words, the exponent 5m is given values as described in the specification. It is not to be construed as the value obtained by multiplying the variable m by five. Further, the mathematical relationship may lead to quantifiable data which can be used to determine an individual's membership in a given population subset.

C may comprise the mathematical relationship expressed in Equation (1), or approximations of the same:

$${C}_{1} = \frac{{TC}^{1 a}}{{HDL}^{1 b} \times {LDL}^{1 c} \times {TG}^{1 d}} \qquad Equation ( 1 )$$

where 1a is about 1; where 1b is about 0.30 to about 0.40, alternatively about 0.33 to about 0.37, alternatively, about 0.35; where 1c is 0 to about 0.35, alternatively, 0.23 to about 0.27, alternatively, about 0.25; and where 1d is about 0 to about 0.08, alternatively, about 0.02 to about 0.06, alternatively, about 0.04. The discriminant direction may comprise the mathematical relationship expressed in Equation (1_{β}) or approximations of the same:

$${C}_{1 β} = \frac{TC}{{HDL}^{0.35} \times {LDL}^{0.25} \times {TG}^{0.04}} \qquad Equation ( {1}_{β} )$$

The discriminant direction (C) may comprise a simplified expression of the mathematical relationship of Equation (1), or approximations of the same, expressed as Equation (1γ):

$${C}_{1} γ = \frac{TC}{{HDL}^{0.35}} \qquad Equation ( 1 γ )$$

The discriminant direction (C) may comprise the mathematical relationship expressed in Equation (2), or approximations of the same:

$${C}_{2} = \frac{{HDL}^{2 a} \times {LDL}^{2 b} \times {TG}^{2 c}}{{TC}^{2 d}} \qquad Equation ( 2 )$$

where 2a is about 0.24 to about 0.39, alternatively about 0.27 to about 0.31, alternatively, about 0.29; where 2b is 0 to about 0.14, alternatively, 0.07 to about 0.11, alternatively, about 0.09; where 2c is 0 to about 0.16, alternatively, about 0.09 to about 0.13, alternatively, about 0.11; and where 2d is about 1. The discriminant direction may comprise the mathematical relationship expressed in Equation (2α) or approximations of the same:

$${C}_{2 α} = \frac{{HDL}^{0.29} \times {LDL}^{0.09} \times {TG}^{0.11}}{TC} \qquad Equation ( 2 α )$$

The discriminant direction (C) may comprise a simplified expression of the mathematical relationship of Equation (2), or approximations of the same, expressed as Equation (2_{β}):

$${C}_{2 β} = \frac{{HDL}^{0.29}}{TC} \qquad Equation ( {2}_{β} )$$

The discriminant direction (C) may comprise the mathematical relationship expressed in Equation (3), or approximations of the same:

$${C}_{3} = \frac{{HDL}^{3 a} \times {LDL}^{3 b} \times {TG}^{3 c}}{{TC}^{3 d}} \qquad Equation ( 3 )$$

where 3a is about 0.49 to about 0.69, alternatively about 0.57 to about 0.61, alternatively, about 0.59; where 3b is about 0.44 to about 0.54, alternatively, 0.47 to about 0.51, alternatively, about 0.49; where 3c is 0 to about 0.06, alternatively, about 0.02 to about 0.04, alternatively, about 0.11; and where 3d is about 1. The discriminant direction may comprise the mathematical relationship expressed in Equation (3_{α}) or approximations of the same:

$${C}_{3 α} = \frac{{HDL}^{0.59} \times {LDL}^{0.49} \times {TG}^{0.03}}{TC} \qquad Equation ( {3}_{α} )$$

The discriminant direction (C) may comprise a simplified expression of the mathematical relationship of Equation (3), or approximations of the same, expressed as Equation (3_{β}):

$${C}_{3 β} = \frac{{HDL}^{0.59} \times {LDL}^{0.49}}{TC} \qquad Equation ( {3}_{β} )$$

The discriminant direction (C) may comprise an expression of a mathematical relationship between an HDL fraction, an LDL-5 fraction, an HDL-2b fraction, and an HDL-3c fraction. The discriminant direction may comprise the mathematical relationship expressed in Equation (4), or approximations of the same:

$${C}_{4} = \frac{\begin{matrix}HDL \text{-} 3 {b}^{4 a} \times LDL \text{-} {5}^{4 b} \times {HDL}^{4 c} \times \\ LDL \text{-} {3}^{4 d} \times HDL \text{-} 2 {a}^{4 e} \times LDL \text{-} {2}^{4 f}\end{matrix}}{\begin{matrix}HDL \text{-} 2 {b}^{4 g} \times HDL \text{-} 3 {c}^{4 h} \times HDL \text{-} 3 {a}^{4 j} \times \\ LDL \text{-} {4}^{4 k} \times d {TRL}^{4 m} \times b {TRL}^{4 n} \times LDL \text{-} {1}^{4 p} \times {Age}^{4 q}\end{matrix}} \qquad Equation ( 4 )$$

where 4a is about 1; where 4b is about 0.72 to about 0.82, alternatively about 0.75 to about 0.79, alternatively, about 0.77; where 4c is about 0.50 to about 0.60, alternatively, 0.53 to about 0.57, alternatively, about 0.55; where 4d is 0 to about 0.37, alternatively, about 0.32; where 4e is 0 to about 0.14, alternatively, about 0.09; where 4f is from 0 to about 0.12, alternatively, about 0.07, where 4g is about 0.88 to about 0.98, alternatively, about 0.91 to about 0.95, alternatively, about 0.93; and where 4h is about 0.72 to about 0.82, alternatively about 0.75 to about 0.79, alternatively, about 0.77; where 4j is 0 to about 0.43, alternatively, about 0.37; where 4k is 0 to about 0.43, alternatively, about 0.37; where 4m is 0 to about 0.22, alternatively, about 0.17; where 4n is 0 to about 0.22, alternatively, about 0.17; where 4p is 0 to about 0.08, alternatively, about 0.03; and where 4q is 0 to about 0.05, alternatively, about 0.01. The discriminant direction may comprise the mathematical relationship expressed in Equation (4A) or approximations of the same:

$${C}_{4 α} = \frac{\begin{matrix}HDL \text{-} 3 b \times LDL \text{-} {5}^{0.77} \times {HDL}^{0.55} \times \\ LDL \text{-} {3}^{0.32} \times HDL \text{-} 2 {a}^{0.09} \times LDL \text{-} {2}^{0.07}\end{matrix}}{\begin{matrix}\begin{matrix}HDL \text{-} 2 {b}^{0.93} \times HDL \text{-} 3 {c}^{0.77} \times \\ HDL \text{-} 3 {a}^{0.37} \times LDL \text{-} {4}^{0.37} \times \end{matrix} \\ d {TRL}^{0.17} \times b {TRL}^{0.17} \times LDL \text{-} {1}^{0.03} \times {Age}^{0.01}\end{matrix}} \qquad Equation ( {4}_{α} )$$

The discriminant direction (C) may comprise a simplified expression of the mathematical relationship of Equation (4), or approximations of the same, expressed as Equation (4_{β}):

$${C}_{4 β} = \frac{HDL \text{-} 3 b \times LDL \text{-} {5}^{0.77} \times {HDL}^{0.55}}{HDL \text{-} 2 {b}^{0.93} \times HDL \text{-} 3 {c}^{0.77}} \qquad Equation ( {4}_{β} )$$

C may comprise an expression of a mathematical relationship between an HDL-2b fraction, an LDL-4 fraction, an HDL-2a fraction, an LDL-5 fraction, and an HDL fraction. C may comprise the mathematical relationship expressed in Equation (5), or approximations of the same:

$${C}_{5} = \frac{\begin{matrix}HDL \text{-} 2 {b}^{5 a} \times LDL \text{-} {4}^{5 b} \times {HDL}^{5 c} \times \\ LDL \text{-} {2}^{5 d} \times LDL \text{-} {1}^{5 e} \times HDL \text{-} 3 {c}^{5 f} \times b {TRL}^{5 g}\end{matrix}}{\begin{matrix}HDL \text{-} 2 {a}^{5 h} \times LDL \text{-} {5}^{5 j} \times LDL \text{-} {3}^{5 k} \times \\ {Age}^{5 m} \times d {TRL}^{5 n} \times HDL \text{-} 3 {c}^{5 p} \times HDL \text{-} 3 {b}^{5 q}\end{matrix}} \qquad Equation ( 5 )$$

where 5a is about 1; where 5b is about 0.38 to about 0.48, alternatively about 0.41 to about 0.45, alternatively, about 0.43; where 5c is 0 to about 0.23, alternatively, about 0.18; where 5d is 0 to about 0.18, alternatively, about 0.13; where 5d is 0 to about 0.18, alternatively, about 0.13; where 5f is 0 to about 0.13, alternatively, about 0.08; where 5g is 0 to about 0.08, alternatively, about 0.03; where 5h is about 0.82 to about 0.92, alternatively, 0.85 to about 0.89, alternatively, about 0.87; where 5j is about 0.60 to about 0.70, alternatively, about 0.63 to about 0.67, alternatively, about 0.65; 5k is 0 to about 0.24, alternatively, about 0.19; where 5m is 0 to about 0.21, alternatively, about 0.16; where 5n is 0 to about 0.16, alternatively, about 0.11; where 5p is 0 to about 0.14, alternatively, about 0.09; and where 5q is 0 to about 0.09, alternatively, about 0.04. The discriminant direction may comprise the mathematical relationship expressed in Equation (5A) or approximations of the same:

$${C}_{5 α} = \frac{\begin{matrix}HDL \text{-} 2 b \times LDL \text{-} {4}^{0.43} \times {HDL}^{0.18} \times \\ \begin{matrix}LDL \text{-} {2}^{0.13} \times LDL \text{-} {1}^{0.13} \times \\ HDL \text{-} 3 {c}^{0.08} \times {bTRL}^{0.33}\end{matrix}\end{matrix}}{\begin{matrix}HDL \text{-} 2 {a}^{0.87} \times LDL \text{-} {5}^{0.65} \times \\ \begin{matrix}LDL \text{-} {3}^{0.19} \times {Age}^{0.16} \times d {TRL}^{0.11} \times \\ HDL \text{-} 3 {c}^{0.09} \times HDL \text{-} 3 {b}^{0.04}\end{matrix}\end{matrix}} \qquad Equation ( {5}_{α} )$$

The discriminant direction (C) may comprise a simplified expression of the mathematical relationship of Equation (5), or approximations of the same, expressed as Equation (5_{β}):

$${C}_{5 β} = \frac{HDL \text{-} 2 b \times LDL \text{-} {4}^{0.43}}{HDL \text{-} 2 {a}^{0.87} \times DL \text{-} {5}^{0.65}} \qquad Equation ( {5}_{β} )$$

The discriminant direction (C) may comprise an expression of a mathematical relationship between an HDL-3b fraction, an HDL-3c fraction, an HDL-2a fraction, an LDL-2a fraction, an LDL-2 fraction, LDL-3 fraction, and an LDL-5 fraction. The discriminant direction may comprise the mathematical relationship expressed in Equation (6), or approximations of the same:

$${C}_{6} = \frac{\begin{matrix}HDL \text{-} 3 {b}^{6 a} \times HDL \text{-} 3 {c}^{6 b} \times HDL \text{-} 2 {a}^{6 c} \times \\ \begin{matrix}LDL \text{-} {2}^{6 d} \times b {TRL}^{6 e} \times {HDL}^{6 f} \times \\ LDL \text{-} {4}^{6 g} \times HDL \text{-} 3 {a}^{6 h} \times d {TRL}^{6 j}\end{matrix}\end{matrix}}{\begin{matrix}LDL \text{-} {3}^{6 k} \times LDL \text{-} {5}^{6 m} \times {Age}^{6 n} \times \\ HDL \text{-} 2 {b}^{6 p} \times LDL \text{-} {1}^{6 q}\end{matrix}} \qquad Equation ( 6 )$$

where 6a is about 1; where 6b is about 0.70 to about 0.80, alternatively about 0.73 to about 0.77, alternatively, about 0.75; where 6c is about 0.56 to about 0.66, alternatively, 0.59 to about 0.63, alternatively, about 0.61; where 6d is about 0.36 to about 0.46, alternatively, about 0.39 to about 0.43, alternatively, about 0.41; where 6e is 0 to about 0.25, alternatively, about 0.20; where 6f is 0 to about 0.24, alternatively, about 0.19; where 6g is 0 to about 0.21, alternatively, about 0.16; where 6h is 0 to about 0.14, alternatively, about 0.09; where 6j is 0 to about 0.07, alternatively, about 0.02; where 6k is about 0.46 to about 0.56, alternatively, about 0.49 to about 0.53, alternatively, about 0.51; where 6m is about 0.37 to about 0.47, alternatively, about 0.40 to about 0.44, alternatively, about 0.42; where 6n is 0 to about 0.44, alternatively, about 0.39; where 6p is 0 to about 0.42, alternatively, about 0.37; and where 6q is 0 to about 0.34, alternatively, about 0.29. The discriminant direction may comprise the mathematical relationship expressed in Equation (6_{α}) or approximations of the same:

$${C}_{6 α} = \frac{\begin{matrix}HDL \text{-} 3 b \times HDL \text{-} 3 {c}^{0.75} \times HDL \text{-} 2 {a}^{0.61} \times \\ \begin{matrix}LDL \text{-} {2}^{0.41} \times b {TRL}^{0.20} \times {HDL}^{0.19} \times \\ LDL \text{-} {4}^{0.16} \times HDL \text{-} 3 {a}^{0.09} \times d {TRL}^{0.02}\end{matrix}\end{matrix}}{\begin{matrix}LDL \text{-} {3}^{0.51} \times LDL \text{-} {5}^{0.42} \times {Age}^{0.39} \times \\ HDL \text{-} 2 {b}^{0.37} \times LDL \text{-} {1}^{0.29}\end{matrix}} \qquad Equation ( {6}_{α} )$$

The discriminant direction (C) may comprise a simplified expression of the mathematical relationship of Equation (6), or approximations of the same, expressed as Equation (6_{β}):

$${C}_{6 β} = \frac{\begin{matrix}HDL \text{-} 3 b \times HDL \text{-} 3 {c}^{0.75} \times \\ HDL \text{-} 2 {a}^{0.61} \times LDL \text{-} {2}^{0.41}\end{matrix}}{LDL \text{-} {3}^{0.51} \times LDL \text{-} {5}^{0.42}} \qquad Equation ( {6}_{β} )$$

The discriminant direction (C) may comprise an expression of a mathematical relationship between an HDL-3b fraction, an LDL-2 fraction, an HDL-3c fraction, and LDL-3 fraction. The discriminant direction may comprise the mathematical relationship expressed in Equation (7), or approximations of the same:

$${C}_{7} = \frac{\begin{matrix}HDL \text{-} 3 {b}^{7 a} \times LDL \text{-} {2}^{7 b} \times LDL \text{-} {4}^{7 c} \times \\ {Age}^{7 d} \times LDL \text{-} {1}^{7 e} \times {HDL}^{7 f}\end{matrix}}{\begin{matrix}HDL \text{-} 3 {c}^{7 g} \times LDL \text{-} {3}^{7 h} \times \\ \begin{matrix}HDL \text{-} 3 {a}^{7 j} \times b {TRL}^{7 k} \times d {TRL}^{7 m} \times \\ HDL \text{-} 2 {b}^{7 n} \times LDL \text{-} {5}^{7 p} \times HDL \text{-} 2 {a}^{7 q}\end{matrix}\end{matrix}} \qquad Equation ( 7 )$$

where 7a is about 1; where 7b is about 0.55 to about 0.65, alternatively about 0.58 to about 0.62, alternatively, about 0.60; where 7c is 0 to about 0.44, alternatively about 0.39; where 7d is 0 to about 0.22, alternatively, about 0.17; where 7e is 0 to about 0.09, alternatively, about 0.04; where 7f is 0 to about 0.08, alternatively, about 0.03; where 7g is about 0.78 to about 0.88, alternatively, 0.81 to about 0.85, alternatively, about 0.83; where 7h is about 0.51 to about 0.61, alternatively, about 0.54 to about 0.58, alternatively, about 0.56; where 7j is 0 to about 0.42, alternatively, about 0.37; where 7k is 0 to about 0.27, alternatively, about 0.22; where 7m is 0 to about 0.16, alternatively, about 0.11; where 7n is 0 to about 0.14, alternatively, about 0.09; where 7p is 0 to about 0.10, alternatively, about 0.05; and where 7q is 0 to about 0.06, alternatively, about 0.01. The discriminant direction may comprise the mathematical relationship expressed in Equation (7_{α}) or approximations of the same:

$${C}_{7 α} = \frac{\begin{matrix}HDL \text{-} 3 b \times LDL \text{-} {2}^{0.60} \times LDL \text{-} {4}^{0.39} \times \\ {Age}^{0.17} \times LDL \text{-} {1}^{0.04} \times {HDL}^{0.03}\end{matrix}}{\begin{matrix}HDL \text{-} 3 {c}^{0.83} \times LDL \text{-} {3}^{0.56} \times HDL \text{-} 3 {a}^{0.37} \times {bTRL}^{0.22} \times \\ {dTRL}^{0.11} \times HDL \text{-} 2 {b}^{0.09} \times LDL \text{-} {5}^{0.05} \times HDL \text{-} 2 {a}^{0.01}\end{matrix}} \qquad Equation ( {7}_{α} )$$

The discriminant direction (C) may comprise a simplified expression of the mathematical relationship of Equation (7), or approximations of the same, expressed as Equation (7_{β}):

$${C}_{7 β} = \frac{HDL \text{-} 3 b \times LDL \text{-} {2}^{0.60}}{HDL \text{-} 3 {c}^{0.83} \times LDL \text{-} {3}^{0.56}} \qquad Equation ( {7}_{β} )$$

while SAVE2 is essentially constant.

### Example 9

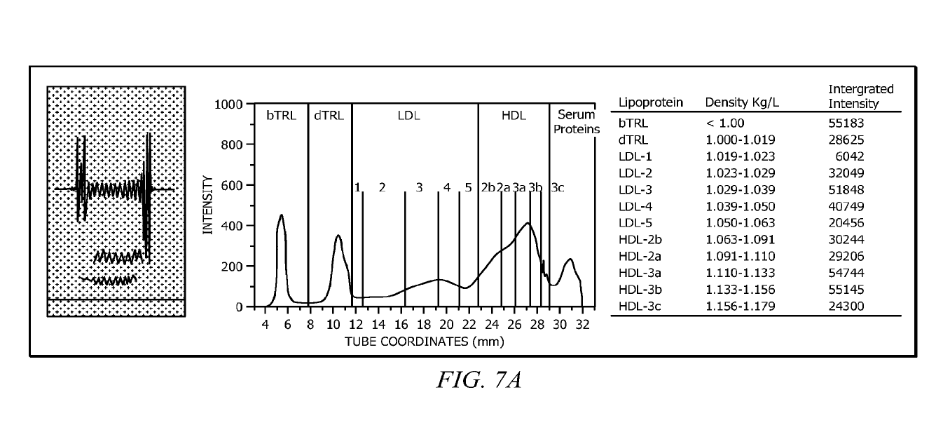

A pilot clinical study used 15 control subjects (or donors) and 15 disease group subjects. All donors had normal LDL-c and normal to elevated HDL-c. Individual serum samples were separated into major lipoprotein subclasses using metal ion chelates of EDTA as described previously herein. The resulting separation was then imaged as shown in the far left panel of FIG. 7A. The image was then processed to produce the lipoprotein profile shown in the center panel of FIG. 7A. Form this profile integrated intensities of the major lipoprotein subclasses were measured and are shown in the far right panel of FIG. 7A.

The groups were classified using the integrated fluorescence intensities of the 12 lipoprotein subclasses described previously herein. The integrated intensities were then subjected to LDA and SAVE. Two correlatives found by LDA were log [LDL-3] intensity and log [HDL-2b] intensity. Back transformation of the logs resulted in the relevant ratio of the two predictors being LDL-3/HDL-2b. Utilizing just this relationship, LDA separates 83.3% of the 30 cases correctly as either CVD or control. This is graphically depicted in FIG. 7B.

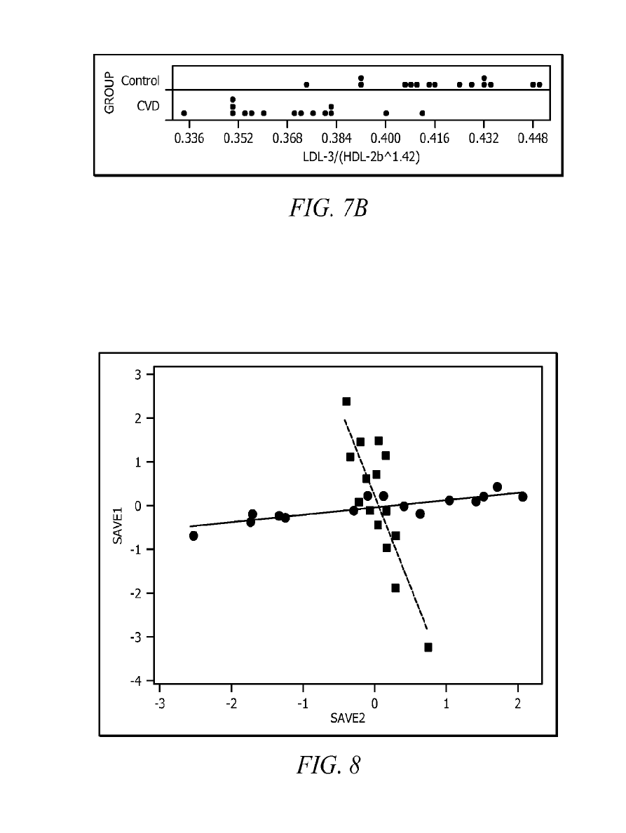

The data was also subjected to analysis using the statistical correlation method SAVE. SAVE seeks to find linear combinations of the predictor variables which best separates the two groups in terms of the mean, variance and covariance of these linear combinations. This makes SAVE a multidimensional separation. FIG. 8 shows a graphical representation of the two dimensions produced by SAVE for the data set in the log transformation. It is readily apparent that the slopes of the two lines in FIG. 8 are very different. Therefore, the covariance or relationship differs across the control and CVD group. Thus, SAVE has found two linear combinations capable of classifying these two groups. Interestingly, the values of SAVE1 for the control group are relatively constant while they change dramatically for the CVD group. The most significant variables were found to be an associated HDL-5a and HDL-3b comparison of exponential power. Then by back transforming the logs, the relevant ratio of these variables is HDL-3a/HDL-3b^{0.86}. Similarly the second dimension of the SAVE analysis was reviewed. In the second SAVE dimension the SAVE−2 values for the CVD subjects is relatively constant and varies dramatically for the control subjects. From this linear combination we found the relevant ratio of these variables was HDL-3b/HDL-5c^{0.78}.

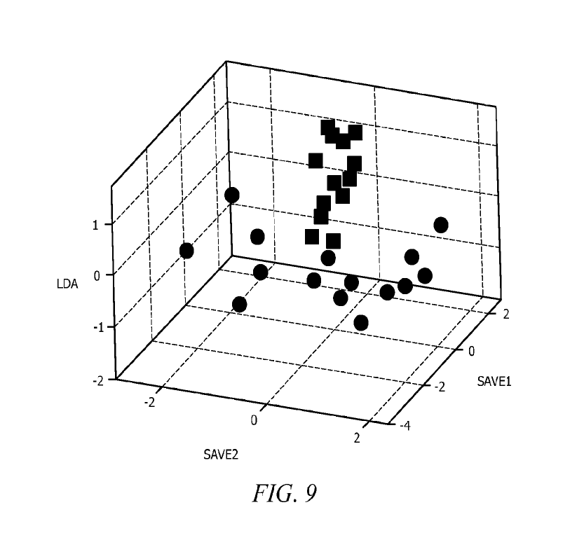

The classification power of the disclosed methodologies was improved by combining SAVE and LDA to produce a three-dimensional plot of LDA, SAVE1, and SAVE 2, FIG. 9. It is clear from this plot that the two groups of points are close to being disjoint (i.e., have very little overlap). The fact that the groups are so well separated is evidence that this analysis is highly effective for classifying cohorts.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural or other details supplementary to the disclosure.

What is claimed is:

1.-64. (canceled)

65. A method of characterizing a biological sample comprising:
separating the biological sample into constituents;
observing the separated constituents;
applying statistical classification modeling to the observed constituents;
deriving quantifiable data from the applied statistical classification modeling; and
analyzing the data from the applied statistical classification modeling to assess a donor of the biological compounds' health.

66. The method of claim 65, wherein the biological sample comprises blood, serum, proteins, lipoproteins, cells, cell constituents, microorganisms, DNA, or combinations thereof.

67. The method of claim 65, wherein the separation of the biological sample, preferably by size or density of combinations thereof, into constituents is effected by density gradient ultracentrifugation, gradient gel electrophoresis, capillary electrophoresis, ultracentrifugation-vertical auto profile, nuclear magnetic resonance, tube gel electrophoresis, chromatography, or combinations thereof.

68. The method of claim 65, wherein the biological sample is suspended in media comprising inorganic salts, cesium chloride, potassium bromide, sodium chloride, sucrose, a synthetic polysaccharide made by crosslinking sucrose, a suspension of silica particles coated with polyvinylpyrrolidone, derivatives of metrizoic acid, dimers of metrizoic acid, Optiprep®, and metal ion chelate complexes.

69. The method of claim 68, wherein the metal ion chelate complexes comprise
(i) metal ions, preferably copper, iron, bismuth, zinc cadmium, calcium, thorium, manganese, lithium sodium potassium, cesium, magnesium, calcium, ammonium, ammonium complexes, tetrabutylammonium, or combinations thereof, and chelating agents; or
(ii) CsBiEDTA, NaCuEDTA, NaFeEDTA, NaBiEDTA, Cs₂CdEDTA, Na₂CdEDTA, or combinations thereof.

70. The method of claim 69, wherein the chelating agents comprise polydentate ligands, preferably oxalate, ethylenediamine, diethylenetriamine, 1,3,5 triminocyclohexane, ethlylenediaminetertaacetic acid (EDTA), or combinations thereof.

71. The method of claim 65, wherein the observed constituents comprise low density lipoprotein (LDL), very low density lipoprotein (VLLP), intermediate density lipoprotein (IDL), high density lipoprotein (HDL), lipoprotein(a) (Lp(a)), bTRL, dTRL, LDL-1, LDL-2, LDL-3, LDL-4, LDL-5, HDL-2b, HDL-2a, HDL-3b, HDL-3c, APOC1HDL, TC, LDL-C, HDL-C, TG, or combinations thereof.

72. The method of claim 65, wherein observation of the constituents comprises
(i) photography, videography, microscopy, nuclear magnetic resonance imaging, computer scanning, human visualization, or combinations thereof; and/or
(ii) confirming and qualifying the presence of constituent components.

73. The method of claim 65, wherein the statistical classification modeling comprises
(i) linear discrimination analysis (LDA), recursive partitioning (RP), sliced average variance estimation (SAVE), sliced mean variance covariance (SMVCIR), or combinations thereof; and, optionally, further comprising
(ii) consideration of age, hypertension, hyperlipidemia, family history, gender, tobacco use, alcohol use, other health related factors, or combinations thereof.

74. A system for characterizing a biological sample comprising:
a biological sample separator, preferably a centrifuge, a gel electrophoresis system, a chromatography system, capillary electrophoresis system, or combinations thereof, wherein the biological sample separator functions to separate the biological sample into constituents;
a constituent observer, preferably a photography device, a videography device, a microscopy device, a nuclear magnetic resonance imaging device, a computer scanning device, a human visualization device, or combinations thereof, wherein the constituent observer functions to confirm and qualify the presence of the constituent;
a constituent statistical processor, preferably a computer, software, a mathematical computation device, or combinations thereof, wherein the constituent statistical processor functions to apply statistical classification modeling to the observed constituent to derive representative data; and
a statistical analyzer, preferably a computer, software, a mathematical computation device, or combinations thereof, wherein the statistical analyzer functions to compare the representative data to benchmark values to derive a predictor for a health concern.

75. A method of determining a benchmark for health assessment comprising:
separating a biological sample into constituents;
observing the separated constituents;
applying statistical classification modeling to the observed constituents;
correlating the observed constituents to a health concern; and
performing an amount of correlations of components to health concerns to achieve a statistically significant predictor.

76. A method of assessing a individual's health comprising:
applying statistical classification modeling to an individual's assessment sample;
deriving quantifiable data from the applied statistical classification modeling; and
analyzing the data from the applied statistical classification modeling to assess the individual's health.

77. The method of claim 65, wherein the statistical classification modeling comprises linear discrimination analysis (LDA), recursive partitioning (RP), sliced average variance estimation (SAVE), sliced mean variance covariance (SMVCIR), or combinations thereof.

78. The method of claim 65, wherein the quantifiable data comprises
$$\frac{TC}{{HDL}^{0.35} {LDL}^{0.25} {TG}^{0.04}} , \frac{{HDL}^{0.29} {LDL}^{0.09} {TG}^{0.11}}{TC} , \frac{{HDL}^{0.59} {LDL}^{0.49} {TG}^{0.03}}{TC} , \frac{HDL \text{-} 3 b \times LDL \text{-} {5}^{0.77} {HDL}^{0.55}}{HDL \text{-} 2 {b}^{0.93} HDL \text{-} 3 {c}^{0.77}} , \frac{HDL \text{-} 2 b \times LDL \text{-} {4}^{0.43}}{HDL \text{-} 2 {a}^{0.87} LDL \text{-} {5}^{0.65}} , \frac{HDL \text{-} 3 b \times HDL \text{-} 3 {c}^{0.75} HDL \text{-} 2 {a}^{0.61} LDL \text{-} {2}^{0.41}}{LDL \text{-} {3}^{0.51} LDL \text{-} {5}^{0.42}} , \frac{HDL \text{-} 3 b \times LDL \text{-} {2}^{0.60}}{HDL \text{-} 3 {c}^{0.83} LDL \text{-} {3}^{0.56}} ,$$
or combinations thereof.

79. The method of claim 65, wherein analyzing the data from the applied statistical classification modeling comprises comparing the data to a benchmark value.

80. The method of claim 65, wherein the assessment of the individual's health comprises identifying cardio vascular disease, genetic disorders, coronary heart disease, a disease that influences lipoproteins, or combinations thereof.
